(19) United States
(12) Patent Application Publication
(10) Pub. No.: US 2018/0219810 A1
(43) Pub. Date: Aug. 2, 2018

(54) TRANSMITTING TAGGED ELECTRONIC MESSAGES

(71) Applicant: MEZZEMAIL LLC, BALTIMORE, MD (US)

(72) Inventors: LUIS SAMAI SANTOS RAMIREZ, COLLEGE PARK, MD (US); KAILYN CAGE, BOWIE, MD (US); YORK EGGLESTON, Baltimore, MD (US); WILLIAM LEE MAPP, III, UPPER MARLBORO, MD (US)

(21) Appl. No.: 15/937,318

(22) Filed: Mar. 27, 2018

Related U.S. Application Data
(63) Continuation-in-part of application No. 15/250,900, filed on Aug. 29, 2016.

(51) Int. Cl. H04L 12/58

(52) U.S. Cl. CPC H04L 51/04; H04L 51/08; H04L 51/10

(57) ABSTRACT

The subject disclosure relates to deploying segments of global and local message content to form several distinct email messages for transmission in a single send instance. In an example, a method comprises assigning, by a system operatively coupled to a processor, a set of tag data to a set of content data within a message, wherein a first subset of tag data is assigned to a first subset of content data and a second subset of tag data is assigned to a second subset of content data. In another aspect, the system comprises transmitting, by the system, the first subset of content data to a first device based on the first subset of tag data and the second subset of content data to a second device based on the second subset of tag data.

### CROSS-REFERENCE TO RELATED APPLICATION

This application claims priority to and claims the benefit of priority to U.S. patent application Ser. No. 15/250,900, filed on Aug. 29, 2016 and entitled “Different Specific Messaging to Multiple Recipients from a Single Message”, which claims priority to U.S. Patent Application No. 62/211,801, filed on Aug. 30, 2015, and entitled “Different Specific Messaging to Multiple Recipients from a Single Message”. The entirety of the disclosure of the aforementioned application is considered part of, and is incorporated by reference in, the disclosure of this application.

### BACKGROUND

Email messaging systems used in the present day were first developed in the 1960s with the increase in the use of computer systems. Conventional emails systems are an extension of the telegraph invention, which was developed in the 1800s. The telegraph systems, message transmission through wire, and Morse code systems, message transmission through airways, were the first systems to allow messages to be sent and received without human delivery systems. These inventions eventually replaced the need for message only mail delivery based on a human courier. However, the early and current email messaging systems focus on how to send, manipulate, store, and categorize a singular message, and multimedia attachments. In current systems, a sender can designate a single or multiple recipients to receive the same singular message. In this conventional technique, all recipients receive the same message content at the same instance in time.

Email systems can be separated into two distinct subsystems based on the X.400 email standardization process. The first subsystem is the message handling system (MHS), which is responsible for moving email messages from the sender to recipient(s) built on a set of servers called message transfer agents (MTA). The first subsystem is responsible for the traditional parsing mechanisms that enabled a sender's message to be decoded at different instances and/or levels to navigate to the correct network and eventually the recipient's mailbox. MTAs provide the ability to transfer a common message from a sender to one or multiple recipients. The emphasis of MTA development was focused on reliably moving messages from the sender to the recipient(s) and the routing mechanism. There was no emphasis or foresight during the initial development of the Internet and Internet email on subsequent innovations.

The second subsystem is user agents (UA), which works with the user to receive, manage, and create email messages interacting with a message handling system to have messages delivered. Traditionally, UA's have focused on the formatting of electronic messages that could provide a standard language for all messaging systems. Given the antiquated nature of email systems, there is a need for new innovations for efficiently and qualitatively transmitting email messages between users. Furthermore, improvements and innovations need be developed in relation to MTAs. The traditional and current email MTAs are centrically focused on the domain, host, and email address for delivering messages to recipients. Research efforts over the last 50 years of email development have been centrally focused on making MTAs more efficient and less complex for system administrators with regard to sending and receiving messages.

The concept of email is largely based on packet switching, which is responsible for the networking capabilities of the Internet and the ability for users to access and share information. Packet switching breaks messages into chunks called packets which would then be routed between computers through fast switching routing procedures. While packet switching in this network-based context is referring to the ability to access local data (images, files, search abilities, messaging capabilities (transmission, receipt, composition)) from one networked computer to another networked computer in any location.

Current email systems are based in the simple mail transfer protocol (SMTP) extensions and the RFC-1426 document. This protocol allows for the transmission of messages in and on the network and locally for archival. After data is transmitted, packet switching occurs where transmitted data is grouped into adequately sized blocks called “packets” and transmitted through a medium shared by multiple simultaneous communication sessions. Innovation on packet switching has been explored in research and development with emphasis on advancing the speed of packet switching. In this respect, new and improved mechanisms or architectures for transmitting data are required.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that employ system components to facilitate a transmission of multiple different messages to different recipients through a single message in a send instance.

According to an embodiment, a system is provided. The system comprises a processor that executes computer executable components stored in memory. The computer executable components comprise a tagging component that assigns a set of tag data to a set of content data within a message, wherein at least a first subset of tag data is assigned to at least a first subset of content data and at least a second subset of tag data is assigned to at least a second subset of content data. Furthermore, the computer executable components comprise a transmission component that transmits at least the first subset of content data to a first device based on the first subset of tag data and at least the second subset of content data that is different than the first subset of content data to a second device based on the second subset of tag data. In another aspect, the computer executable component can comprise a generation component that generates the first subset of content data at the first device and the second subset of data at the second device.

According to another embodiment, a computer-implemented method is provided. The computer-implemented method can comprise assigning, by a system operatively coupled to a processor, a set of tag data to a set of content data within a message, wherein a first subset of tag data is assigned to a first subset of content data and a second subset of tag data is assigned to a second subset of content data. The computer-implemented method can also comprise transmitting, by the system, the first subset of content data to a first device based on the first subset of tag data and the second subset of content data to a second device based on the second subset of tag data. In another aspect, the computer-implemented method can comprise storing, by the system, the first subset of content data, the second subset of content data, the first subset of tag data and the second subset of tag data at one or more data store in accordance with a tag-based organizational framework.

According to yet another embodiment, a computer program product for facilitating a grouping disparate content data points into interoperable data packets for transmission over as mutual content data subsets and individualized content data subsets over a single messaging instance, the computer program product comprising a computer readable storage medium having program instructions embodied therewith. The computer program product can comprise a computer readable storage medium having program instructions embodied therewith, the program instructions executable by a processor to cause the processor to assign a set of tag data to a set of content data within a message, wherein a first subset of tag data is assigned to a first subset of content data and a second subset of tag data is assigned to a second subset of content data is provided. The computer program product can also cause the processor to transmit the first subset of content data to a first device based on the first subset of tag data and the second subset of content data to a second device based on the second subset of tag data. In another aspect, the computer program product can cause the processor to transmit the first subset of content data to a first content sharing platform and the second subset of content data to a second content sharing platform based on a third subset of tag data and a fourth subset of tag data respectively, wherein the third subset of tag data and the fourth subset of tag data represent mapping information to locations associated with the first content sharing platform and the second content sharing platform.

### BRIEF DESCRIPTION OF THE DRAWINGS

FIG. 1A illustrates a block diagram of an example, non-limiting system that can facilitate a transmission of different content segments within a single message to different recipients in a single send instance in accordance with one or more embodiments described herein.

FIG. 1B illustrates a diagram of an example, non-limiting graphical user interface (GUI) of an outbound email message capable of segmenting into several email messages in a single send instance. The email message comprises tag data coupled to segments of content data configured for transmission to several recipient devices corresponding to respective addressees in accordance with one or more embodiments described herein.

FIG. 1C illustrates a diagram of an example, non-limiting graphical user interface (GUI) of an inbound email message comprising segments of global content data received by one or more devices associated with a first addressee and a fourth addressee specified the outbound email message in accordance with one or more embodiments described herein.

FIG. 1D illustrates a diagram of an example, non-limiting graphical user interface (GUI) of an inbound email message comprising segments of global content data and local content data received by one or more devices associated with the third addressee specified in the outbound email message in accordance with one or more embodiments described herein.

FIG. 1E illustrates a diagram of an example, non-limiting graphical user interface (GUI) of an inbound email message comprising segments of global content data and local content data received by one or more devices associated with the second addressee specified in the outbound email message in accordance with one or more embodiments described herein.

FIG. 1F illustrates a diagram of an example, non-limiting graphical user interface (GUI) of an outbound email message capable of segmenting into several email messages in a single send instance. The email message comprises segments of global content and local content within the subject field and the message field for transmission to several recipient devices corresponding to respective addressees in accordance with one or more embodiments described herein.

FIG. 1G illustrates a diagram of an example, non-limiting graphical user interface (GUI) of an inbound email message comprising segments of global content data received by one or more devices associated with the first addressee and fourth addressee specified in the outbound email message in accordance with one or more embodiments described herein.

FIG. 1H illustrates a diagram of an example, non-limiting graphical user interface (GUI) of an inbound email message comprising segments of global content data and local content data received by one or more devices associated with the third addressee specified in the outbound email message in accordance with one or more embodiments described herein.

FIG. 1I illustrates a diagram of an example, non-limiting graphical user interface (GUI) of an inbound email message comprising segments of global content data and local content data received by one or more devices associated with the second addressee specified in the outbound email message in accordance with one or more embodiments described herein.

FIG. 1J illustrates a diagram of an example, non-limiting graphical user interface (GUI) of an outbound email message capable of segmenting into several email messages in a single send instance. The email message comprises segments of global content and local content within the subject field and the message field for receipt at different respective timings by several recipient devices corresponding to respective addressees in accordance with one or more embodiments described herein.

FIG. 1K illustrates a diagram of an example, non-limiting system environment 100K configured to facilitate a transmission of global and/or local content segment assortments within a single outbound email message in accordance with one or more embodiments.

FIG. 1L illustrates a diagram of an example, non-limiting system environment 100L configured to facilitate a transmission of global and/or local content segment assortments within a single outbound email message in accordance with one or more embodiments.

FIG. 2, illustrates a block diagram of an example, non-limiting system that can facilitate a generation of several inbound email messages comprising different global and local content segment assortments in connection with a single outbound email message in accordance with one or more embodiments described herein.

FIG. 3 illustrates a block diagram of an example, non-limiting system that can facilitate a storage of subsets of content data and tag data at one or more data store in accordance with one or more embodiments described herein.

FIG. 4, illustrates a block diagram of an example, non-limiting system that can facilitate a retrieval of segments of global content data and local content data in accordance with one or more embodiments described herein.

FIG. 5, illustrates a block diagram of an example, non-limiting system that can facilitate a grouping of content segments based on assigned tag data in accordance with one or more embodiments described herein.

FIG. 6, illustrates a block diagram of an example, non-limiting system that can facilitate a translation of the global and local content segments into different languages in accordance with one or more embodiments described herein.

FIG. 7, illustrates a block diagram of an example, non-limiting system that can facilitate an integration of several data points into a segment of content data in accordance with one or more embodiments described herein.

FIG. 8, illustrates a block diagram of an example, non-limiting system that can facilitate a transmission of global content and local content within sharing platforms in accordance with one or more embodiments described herein.

FIG. 9, illustrates a block diagram of an example, non-limiting system that can facilitate a transmission of email messages to several user devices via a networked system architecture in accordance with one or more embodiments described herein.

FIG. 10 illustrates a flow diagram of an example, non-limiting computer-implemented method 1000 that can facilitate a transmission of segments of global content and local content as several varied email messages to several destinations in a single transmission instance in accordance with one or more embodiments described herein.

FIG. 11 illustrates a flow diagram of an example, non-limiting computer-implemented method 1100 that can facilitate a transmission of segments of global content and local content as several varied email messages to several destinations in a single transmission instance in accordance with one or more embodiments described herein.

FIG. 12 illustrates a flow diagram of an example, non-limiting computer-implemented method 1200 that can facilitate a transmission of segments of global content and local content as several varied email messages to several destinations in a single transmission instance in accordance with one or more embodiments described herein.

FIG. 13 illustrates a flow diagram of an example, non-limiting computer-implemented method 1300 that can facilitate a transmission of segments of global content and local content as several varied email messages to several destinations in a single transmission instance in accordance with one or more embodiments described herein.

FIG. 14 illustrates a flow diagram of an example, non-limiting computer-implemented method 1400 that can facilitate a transmission of segments of global content and local content as several varied email messages to several destinations in a single transmission instance in accordance with one or more embodiments described herein.

FIG. 15 illustrates a flow diagram of an example, non-limiting computer-implemented method 1500 that can facilitate a transmission of segments of global content and local content as several varied email messages to several destinations in a single transmission instance in accordance with one or more embodiments described herein.

FIG. 16 illustrates a flow diagram of an example, non-limiting computer-implemented method 1600 that can facilitate a transmission of segments of global content and local content as several varied email messages to several destinations in a single transmission instance in accordance with one or more embodiments described herein.

FIG. 17 illustrates a flow diagram of an example, non-limiting computer-implemented method 1700 that can facilitate a transmission of segments of global content and local content as several varied email messages to several destinations in a single transmission instance in accordance with one or more embodiments described herein.

FIG. 18 illustrates a flow diagram of an example, non-limiting computer-implemented method that facilitates a configuration of the first device from an application executing on a second device in accordance with one or more embodiments described herein.

FIG. 19 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In an aspect, disclosed herein are systems, methods, and devices that facilitate a transmission of multiple messages (e.g., email messages, text messages, short message service, instant messaging, etc.,) variants to different recipients using a single email composition such that a set of message content can be composed within one email message, however, variable segments of the set of message content are delivered to different recipients in a single send instance. As such, the disclosed subject matter herein allows for the segmenting of an email message for global transmission of one or more message segments and local or private transmission of another one or more message segments that are different than the global message segments.

For instance, a user (e.g., using a user device) can input message composition data in an email body such that some portions of the message can be transmitted to a group of recipients and accordingly a group of identified user devices can receive particular portions of the email message and other different portions of the message can be directed to respective private users (e.g., private user devices) such that only a specified user device receives such portion of the message. In an aspect, the systems and methods disclosed herein can utilize and improve upon message transfer agents (MTA) technologies to effectuate the focused and reliable routing of message content portions to both global (e.g., a group of user devices) recipient user devices and portions of the message to individualized user devices respectively.

In another aspect, the systems and methods disclosed herein also include innovations associated with the mechanisms in which a user device can receive, manage, create email messages and interact with message handling systems to facilitate composition of original and response messages (e.g., reply messages) to global and local email messages. Furthermore, user agent systems can be utilized to modify (e.g., using a processor) the interactions a sender user experiences as relates to the composing process of an email system. In an aspect, a user agent (e.g., system components that facilitate a management of a user devices emails) interaction can be utilized to facilitate receipt (e.g., by a device such as a server device) of global content intended for delivery to a group of user devices and local content intended for delivery to a particular user device. Furthermore, a user agent (e.g., executing on a device such as a server device) corresponding to a sender device can archive global content segments and local content segments within a single email composition. Also, in an aspect, despite the archiving of all content, a recipient user device (e.g., via a processor) can transmit a response to the received local content portion of the message. The recipient user device (e.g., via device processor) can also select an option to hide or display local content when responding to global content such that other recipient user devices can view the local content and/or the global content.

In another aspect, the systems disclosed herein can execute (e.g., using a processor) operations to employ organizational frameworks to organize email messages (e.g., within a thread) such frameworks can include color coding messages or text to facilitate efficient and user-friendly transmission of messages between user devices. For instance, an original message can comprise a local message content coupled to a first color scheme and a global message content coupled to a second color scheme or no color scheme. As such, a local message recipient user device can execute a response operation by generating a reply message to the local message content that is color-coded. Furthermore, the original sender user device can execute (e.g., using a device processor) a retrieval operation to receive a response from the recipient user device that is color-coded to match the coloring of the original local message content. Accordingly, all the local message content correspondence can be organized under a single color scheme for easy access, viewing, and organization Thus, the systems disclosed herein emphasize innovations to MTA and user agent technologies that allow for new and useful message data parsing capabilities.

Furthermore, the disclosed subject matter comprises innovative packet switching techniques that facilitate inter-operability between data packets in relation to different forms of messaging communication mechanisms. In an aspect, using the systems and methods disclosed herein, a processor can execute multiple transmission operations representing transmission of multiple messages in a single send instance at a single point in time (e.g., multiple messages transmitted to several destinations where each message corresponds to the same time stamp). In another instance, the multiple messages can be comprised of different segments or variations of content within a single composed email message. Accordingly, the multiple transmitted messages from the single send instance can comprise different content within each message. Furthermore, in an aspect, the systems and methods described herein can generate and/or employ tag data representing transmission instructions to segments of content assigned to respective tag data subsets. Also, in an aspect, the tag data can represent instructions that facilitate the performance of interoperability activities between data packets within a composed message. In another aspect, the first tag data can represent location information that allows for first segments of message content within an email message coupled to the first tag data to be transmitted to a destination that is different than another destination that second content segments coupled to second tag data within the same email message are transmitted (e.g., where the first tag data and second tag data are different). In an aspect, the tagging capabilities of the disclosed systems and methods are capable of implementation across several messaging platforms and messaging technologies. Thus, the disclosed systems and methods allow for several messages to be transmitted to different recipients using a single email and one send instance (e.g., associated with a single time stamp).

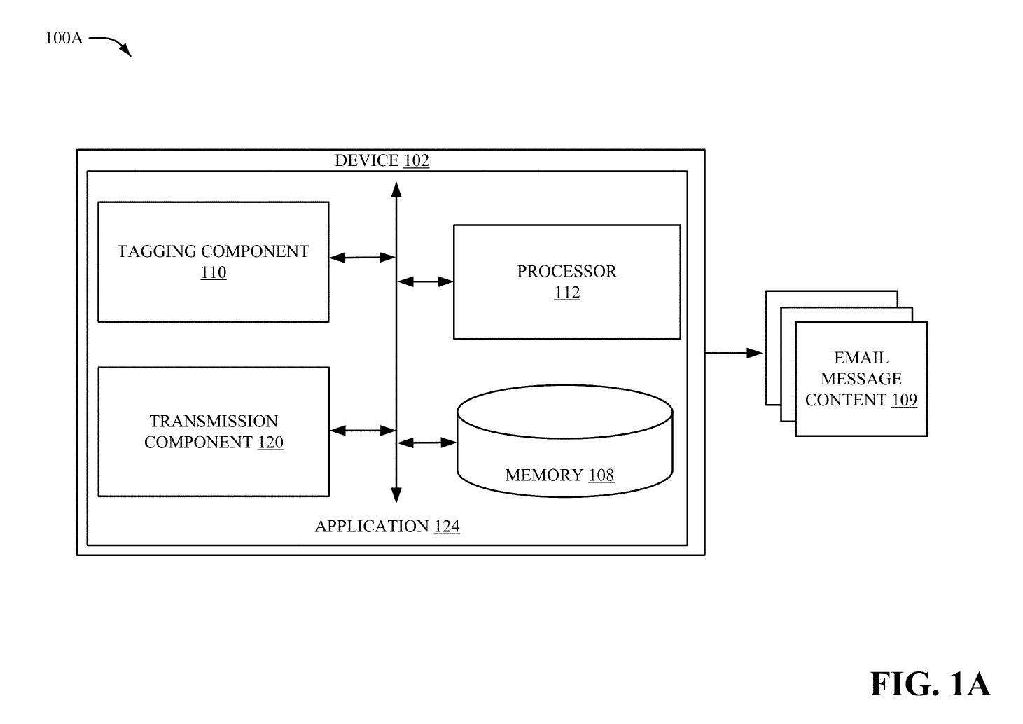

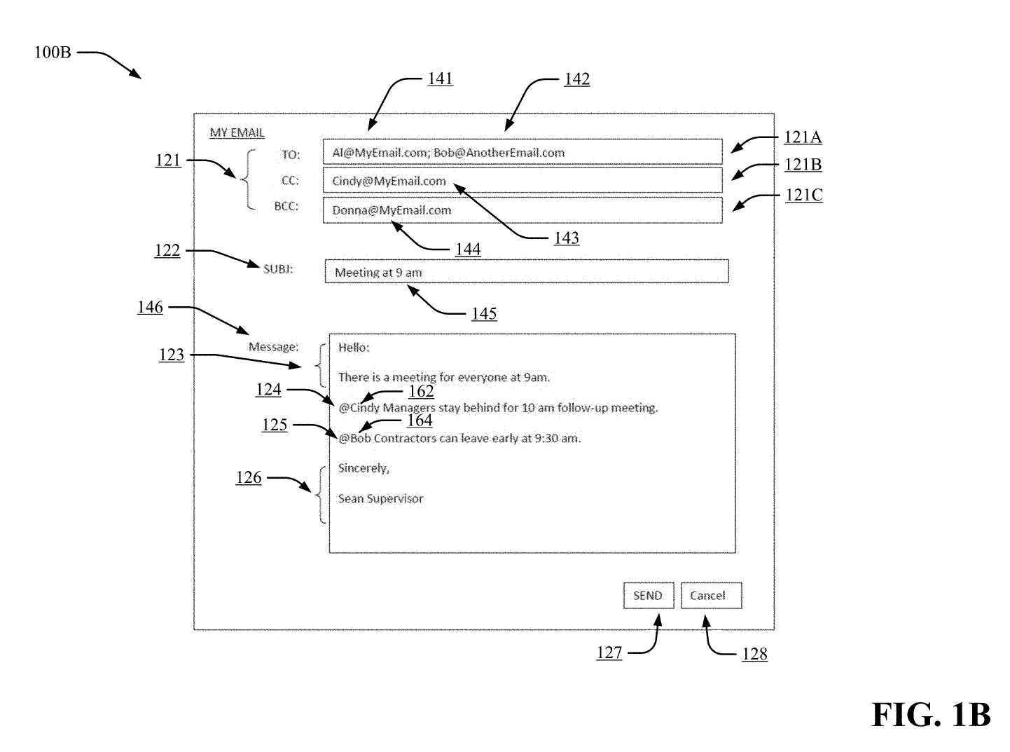

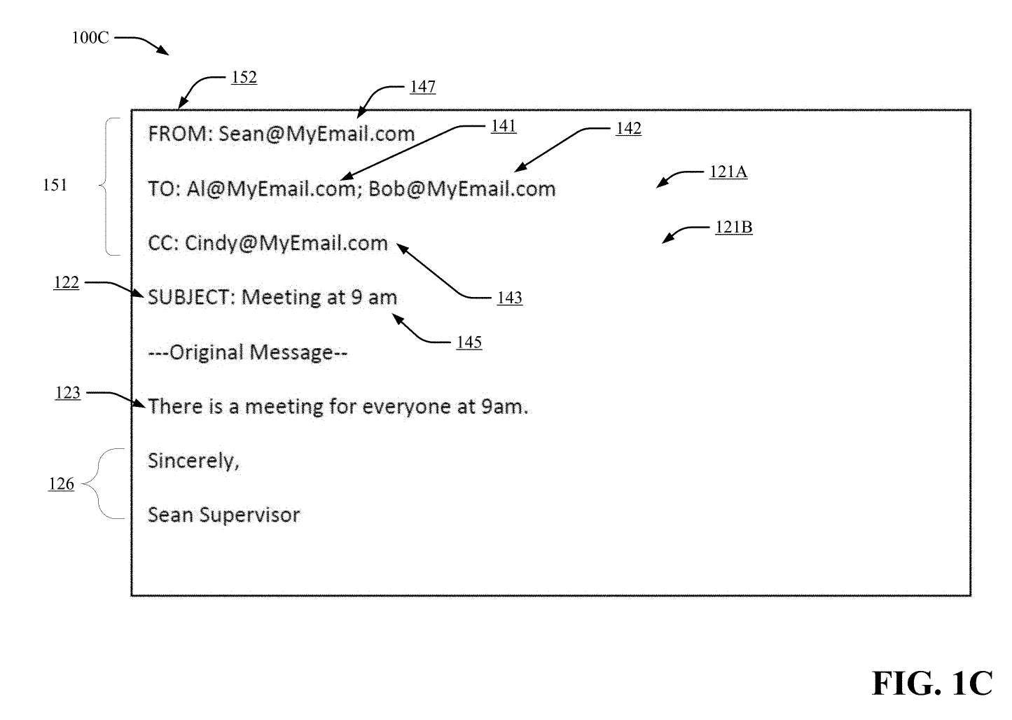

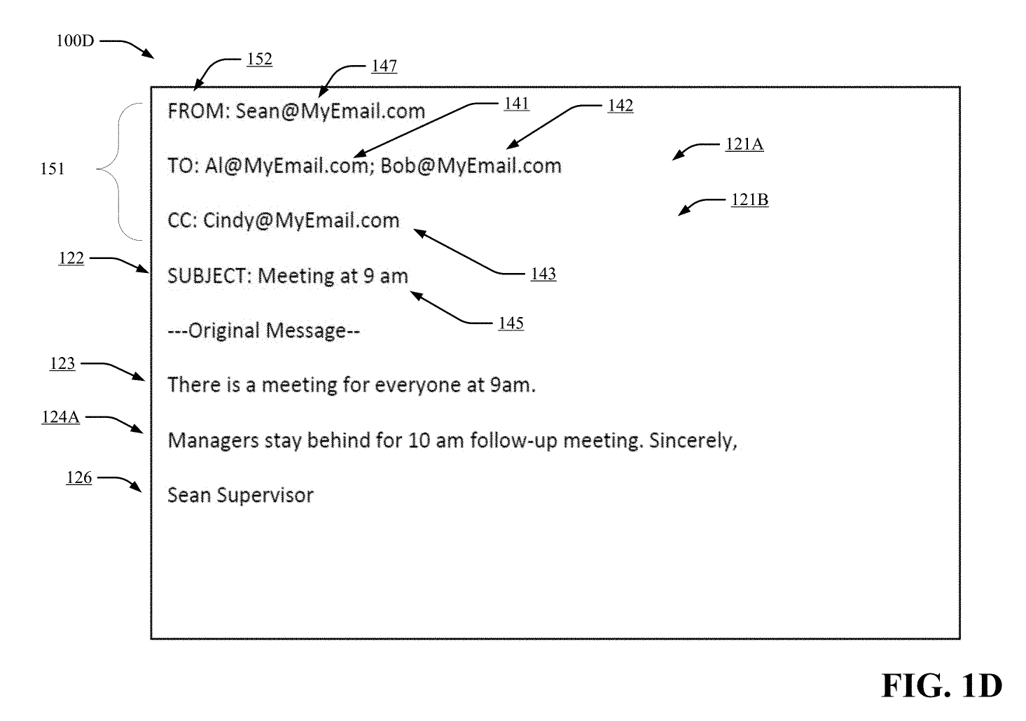

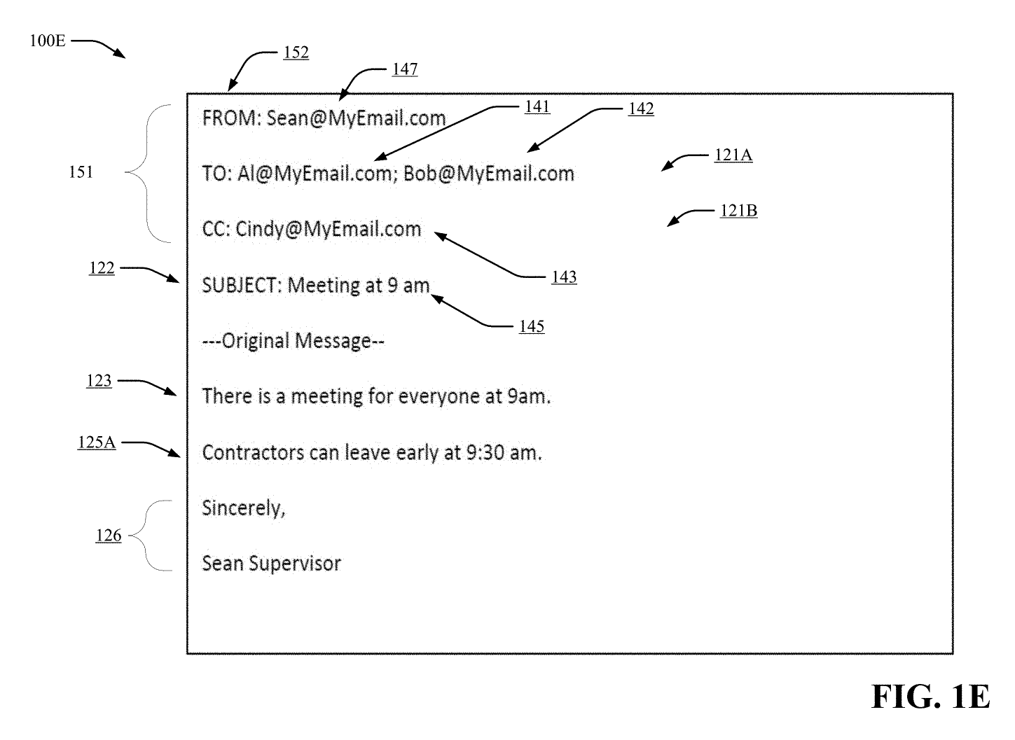

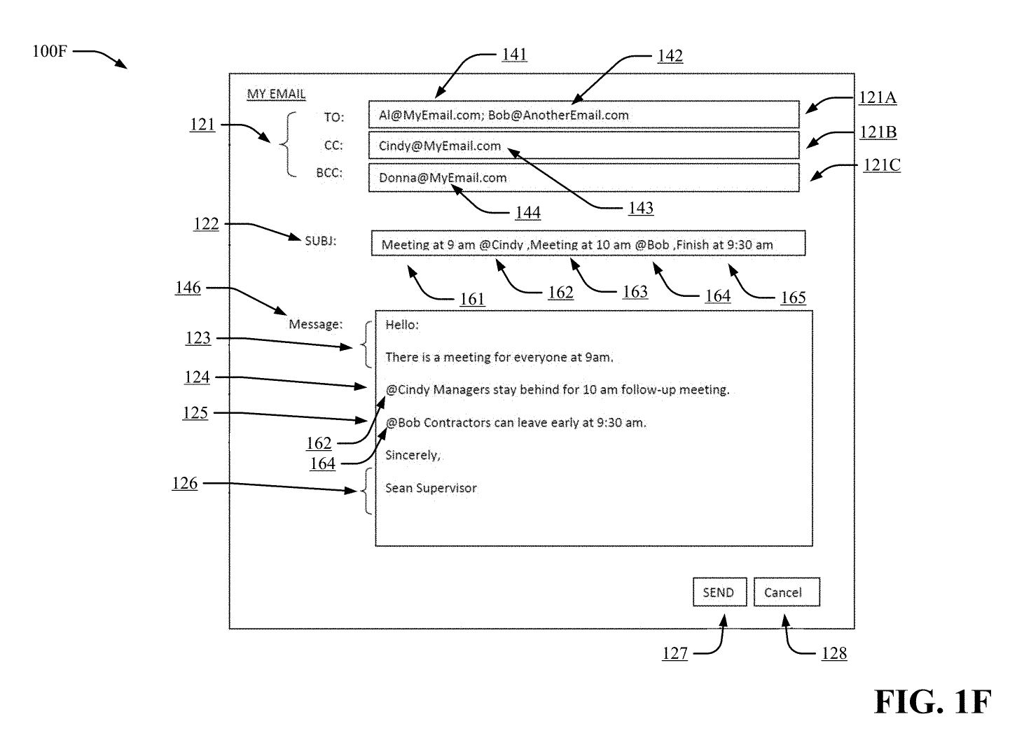

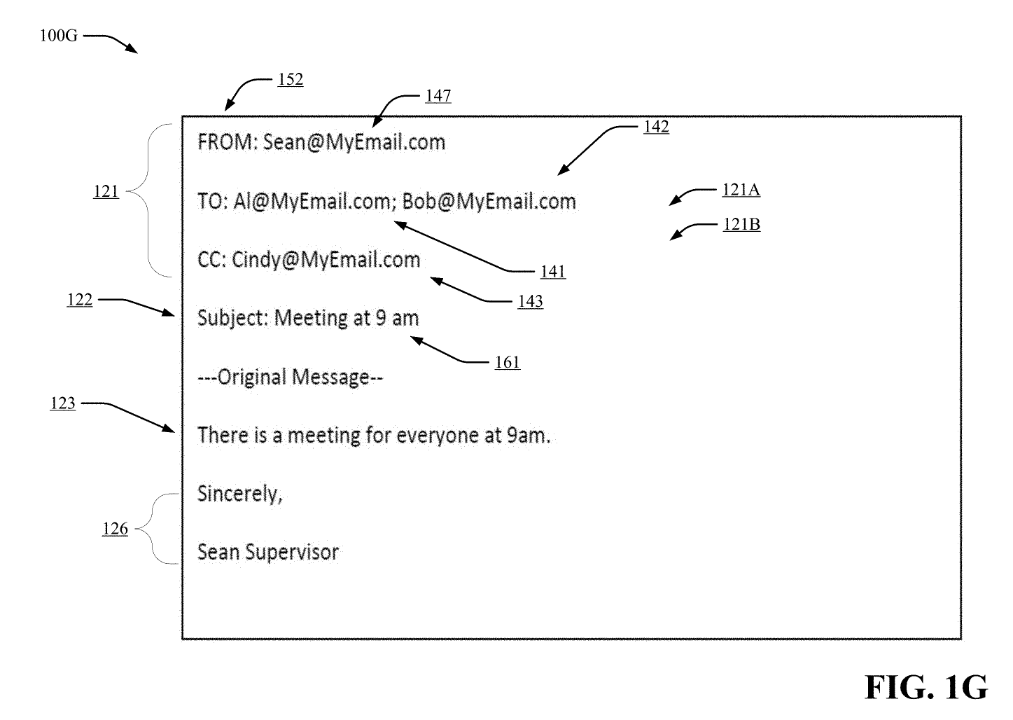

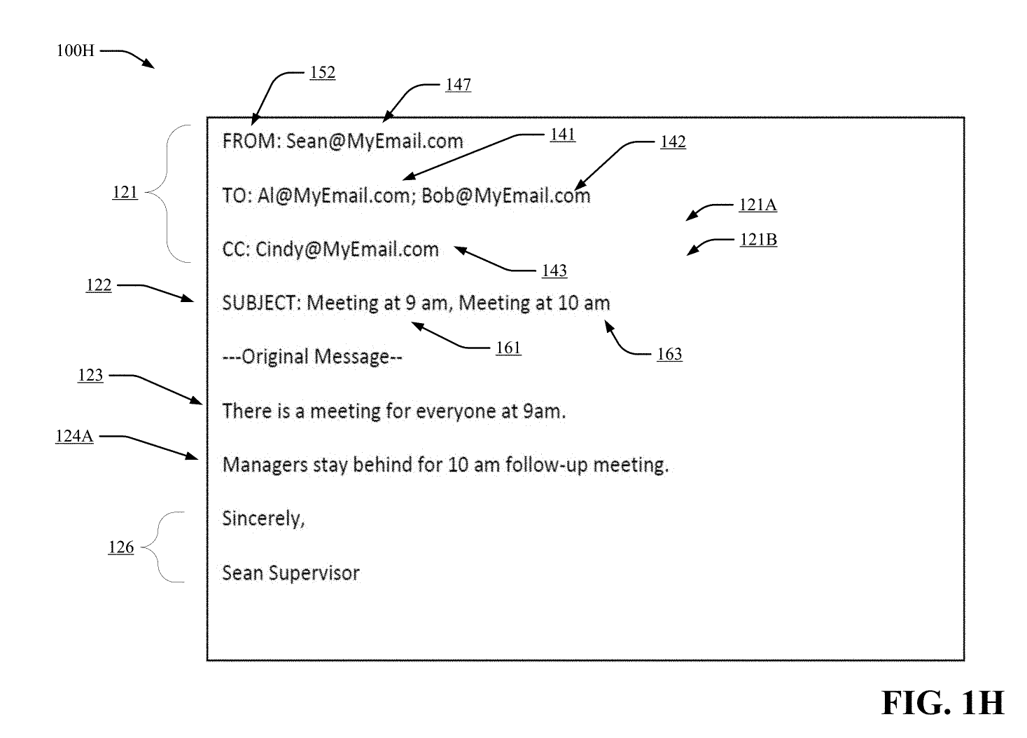

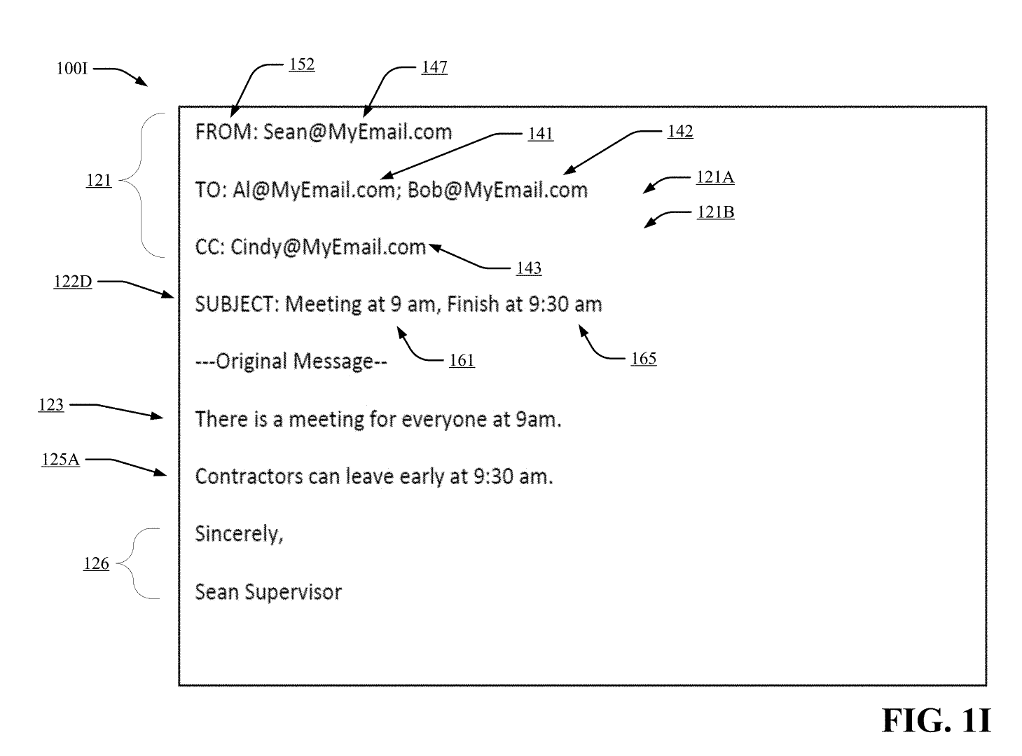

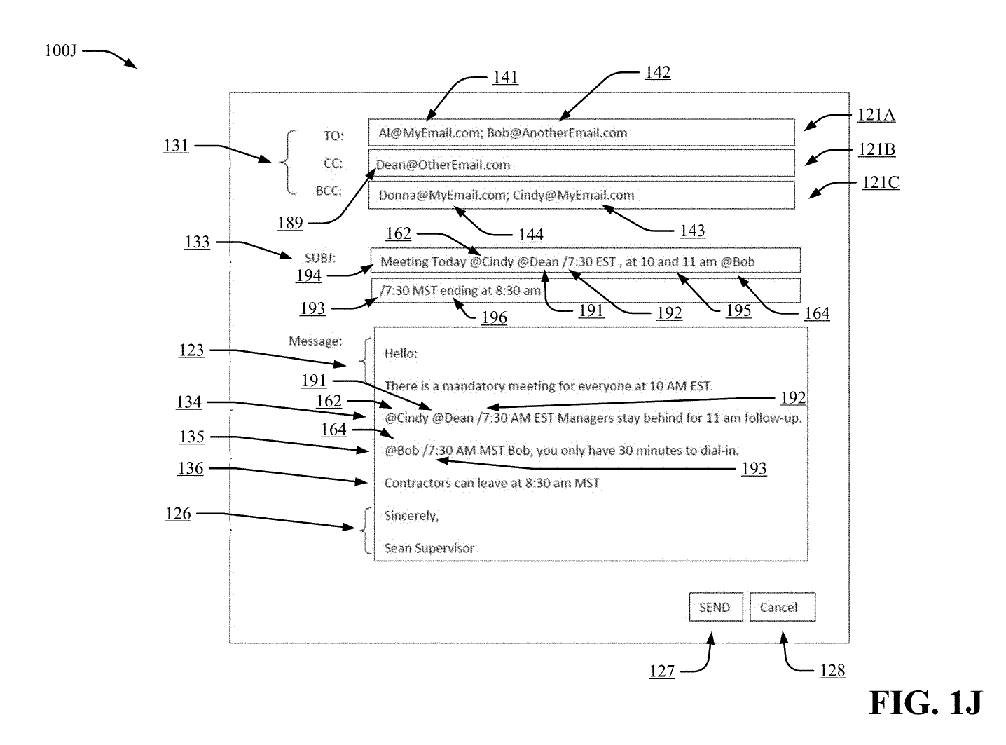

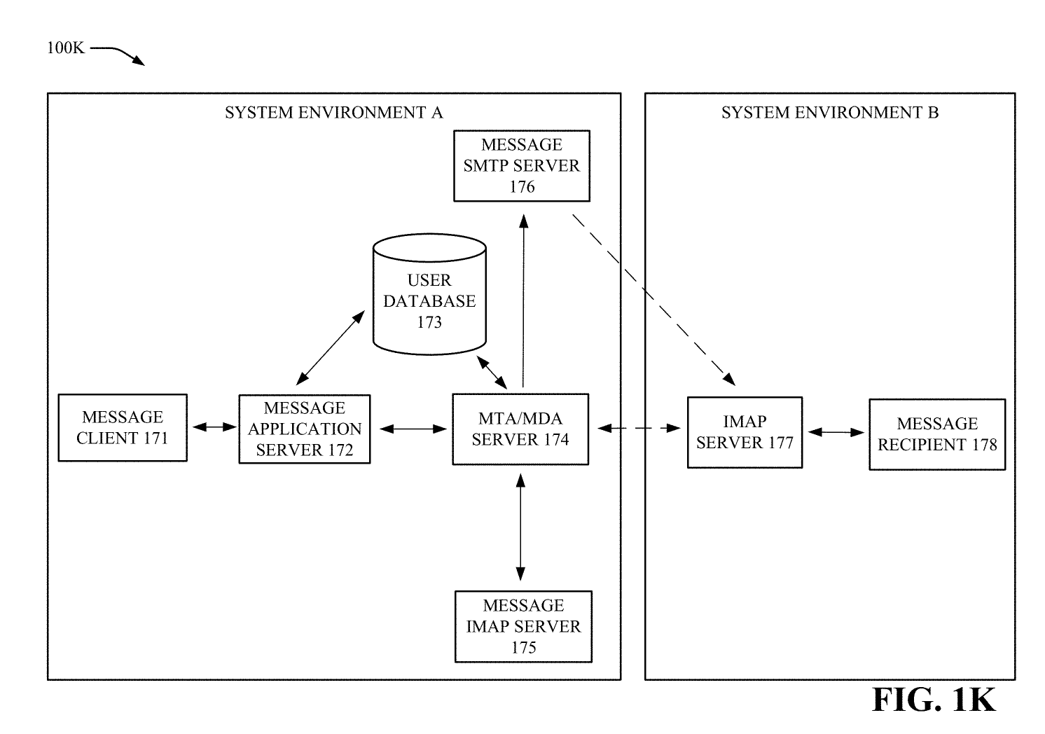

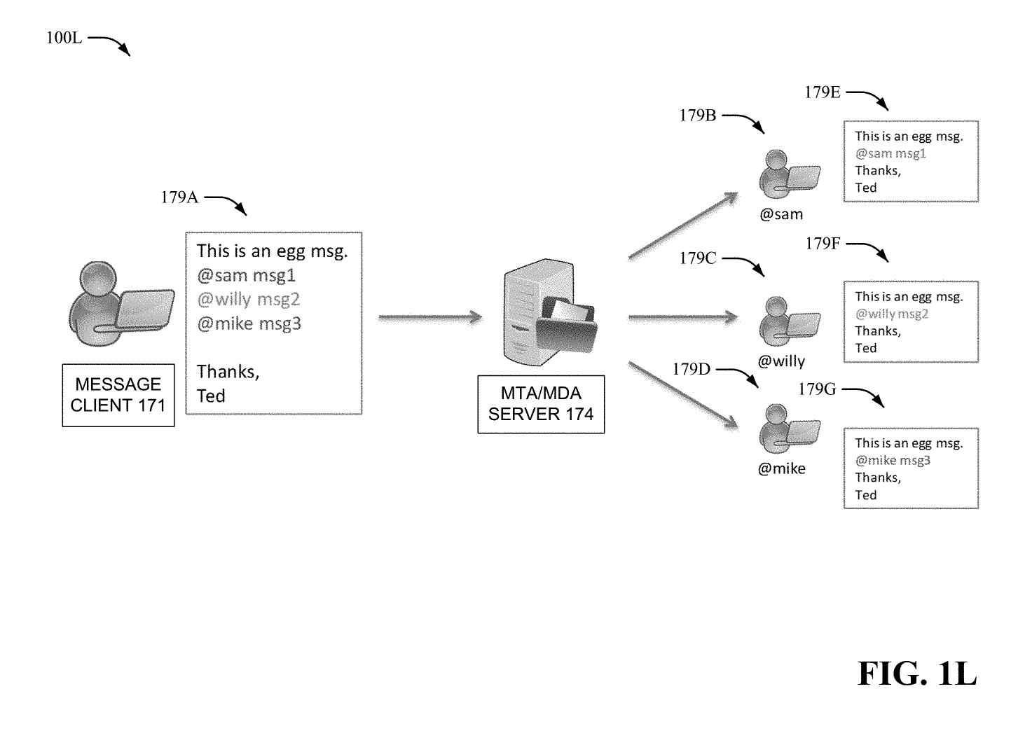

FIG. 1A illustrates a block diagram of an example, non-limiting system that can facilitate a transmission of different content segments within a single message to different recipients in a single send instance in accordance with one or more embodiments described herein. Repetitive description of like elements employed in other embodiments described herein is omitted for sake of brevity.

In an aspect, system 100A can comprise or otherwise access (via a network) tagging component 110 and transmission component 120 executing on device 102. In an aspect, processor 112 can execute the computer executable components and/or computer instructions stored in memory 108. In an aspect, one or more of the components of system 100A can be electrically and/or communicatively coupled to one or more devices of system 100A or other embodiments to perform one or more functions described herein.

In an aspect, system 100A can access a storage element (e.g., memory 108) of device 102 and execute (e.g., using processor 112) a tagging component 110 that can assign a set of tag data to a set of content data within a message, wherein at least a first subset of tag data is assigned to at least a first subset of content data and at least a second subset of tag data is assigned to at least a second subset of content data. In an aspect, device 102 can comprise a smart phone device, server device, media content server, computer, tablet, personal digital assistant, set-top box, or any other such device capable of executing system components to transmit messages. In an aspect, a message can include email messages, text messages, short message service (SMS), instant messaging, enhanced message service (EMS), multimedia message service (MMS), HDML notifications, paging, WAP push, application-to-application messaging, and other messaging types, messaging protocols or messaging formats (hereinafter collectively referred to as “email”, “email messaging”, or “messaging”).

In an instance, current email messaging platforms are problematic in that they do not allow for the transmission of varied content or sub-messages to different recipient user devices using a single email message. Instead, traditional email messaging requires the composition and transmission of several emails one after the other in order to send different content to different intended recipients. In an aspect, system 100A employs capabilities that overcome such issues in that system 100A allows for a user device 102 to receive a set of input data (also referred to as messaging content, global subject line content, global messaging content, local messaging content, local subject line content, etc.) capable of being segmented into subsets of input data such that each subset of input data can be delivered to one or more people and another subset of input data can be delivered to a different one or more people within the same single email message. Furthermore, all the different subsets of input data can be transmitted in a single send instance rather than composing multiple separate emails.

As such, a user device 102 can transmit, in a single email body, several customized email messages for receipt by several user devices with each received email message comprising a customized message for respective user devices. In an aspect, system 100A can employ processor 112 to execute a tagging component 110 (e.g., stored in memory 108) to assign tag data to a set of content data within an email message. In an instance, tag data can comprise location data (e.g., such as a memory location to access content, an archive location to store data, a destination location to transmit data, etc.), timing data (e.g., delivery time of message, time for receipt of message), data capable of characterizing a subset of content data, data capable of describing attributes of a subset of data, and other such data types. In an aspect, tag data can correspond to, impose, or abide by a set of rules, policies, requirements, and/or guidelines. For instance, tag data can abide by a set of rules, non-limiting examples of such rules can include a first rule allowing a tag name to include numbers, letters, and/or characters (e.g., an underscore, an @ sign, etc.), a second rule establishing a maximum length of characters for a tag, a third rule prohibiting a tag name from ending with a type of character (e.g., underscore, forward slash, etc.), and other such rules and/or requirements.

In an instance, tagging component 110 can assign tag data (e.g., an alphanumeric tag) to a subset of content data (e.g., message content). For instance, a first subset of text data (e.g., message content) corresponding to one or more sentences, within a paragraph in the body of an email, can be assigned (e.g., using tagging component 110) first tag data specifying a destination location for the first subset of text data to be transmitted. As such, the tag data can specify a location corresponding to a second user device (e.g., smart phone) as a destination for transmitting the first subset of text data. In an aspect, several subsets of tag data corresponding to different destination locations can be assigned to different subsets of text data within an email body.

For instance, in a non-limiting embodiment, first tag data (e.g., @johndoe) associated with location A (e.g., a memory or data store of a first smart phone owned by John Doe) can be assigned to a first sentence (e.g., first subset of text data) in the body of an email message. Furthermore, second tag data (e.g., @janedoe) associated with location B (e.g., a memory or data store of a second smart phone owned by Jane Doe) can be assigned to a second sentence (e.g., second subset of text data) in an email body. In an instance, a user device can receive transmission input data to perform (e.g., execution by processor 112) a transmission (e.g., using transmission component 120) task that transmit the first sentence and the second sentence of text data within the email message (e.g., email message content 109) to location A (e.g., first subset of text data) and location B (second subset of text data) in a single send instance. In another aspect, the tag data can correspond to an email address of an intended addressee. For instance, tag data represented as @johndoe can correspond to an email address of addressee John Doe, such as JohnDoe@MyEmail.com. As such, the transmission component 120 can utilize (e.g., access, read, etc.) tag data (e.g., email address comprising domain information, mail server information, and local information) to determine a destination (e.g., mail server) for delivery of a particular message (e.g., targeted email messages 109).

In another non-limiting embodiment, first tag data that comprises multiple destinations can be assigned (e.g., via a processor 112 executing tagging component 110) to a first subset of text data such that content segments of an email body can be transmitted to a group of recipients and second tag data comprising fewer destinations than the first tag data can be assigned to a second subset of text data. Thus, an email body can be comprised of global information (e.g., intended for transmission to a group of recipients) and local information (e.g., intended for transmission to a smaller group or an individual recipient). For instance, a first set of tag data (e.g., @johndoe, @georgedoe, @jimdoe) associated with locations A, B, and C (e.g., a memory of a first smart phone, second smart phone and third smart phone owned by John Doe, George Doe, and Jim Doe) can be assigned to a first sentence (e.g., first subset of text data) in an email body. Furthermore, second tag data (e.g., @janedoe) associated with location D (e.g., a memory of a fourth smart phone owned by Jane Doe) can be assigned to a second sentence (e.g., second subset of text data) in an email body. In an instance, a processor executing system components on a user device can receive transmission input data to perform (e.g., execution by processor 112) a transmission (e.g., using transmission component 120) task that transmits the first sentence and the second sentence of text data within the email body to location A, B, and C (e.g., first subset of text data) and location D (second subset of text data) in a single send instance.

In an aspect, processor 112 can execute tagging component 110 to assign tag data to other content within an email message aside from text data within the body of the email. For instance, tag data can be assigned (e.g., using tagging component 110) to subject line content (e.g., text, images, etc.) represented by subject line data such that the subject line data can be transmitted (e.g., using transmission component 120) to different recipient user devices. In another instance, tag data can be assigned (e.g., using tagging component 110) to media content items such as video content files (e.g., comprising video data), audio content files (e.g., comprising audio content data), image content files (e.g., comprising image content files), and other such items. In an aspect, a subset of tag data can be assigned (e.g., using tagging component 110) to each media content item such that different media content items can be transmitted to different user devices based on tag data representing different destinations.

For instance, in a non-limiting embodiment, processor 112 can execute tagging component 110 to perform an assignment operation of first tag data (e.g., @JohnDoe) to first video data (e.g., first video file), second tag data (e.g., @GeorgeDoe and @JimDoe) to image data (e.g., an image file), and third tag data (e.g., @JohnDoe and @JaneDoe) to second video data (e.g., a second video file), where the first video data and second video data are different. As such, a first video can be transmitted (e.g., using transmission component 120) to a first user device (e.g., or mail server device accessible by first user device) corresponding to @JohnDoe, image data can be transmitted (e.g., using transmission component 120) to a second user device and third user device corresponding to @GeorgeDoe and @JimDoe, and second video data can be transmitted (e.g., using transmission component 120) to first user device and fourth user device corresponding to @JohnDoe and @JaneDoe respectively. Furthermore, in an aspect, media content items can be segmented such that a video file (e.g., set of video data) can be segmented into video frames corresponding to a time frame within the video file (e.g., a subset of video data). As such, various video frames (e.g., subsets of video data) can be transmitted to respective user devices based on the video needs.

In another aspect, system 100A can employ processor 112 to execute transmission component 120 that can transmit the first subset of content data to a first device based on the first subset of tag data and the second subset of content data to a second device based on the second subset of tag data. As such, processor 112 can execute transmission component 120 in connection with tagging component 110 to transmit email content data assigned to tag data to a destination device location represented by the tag data. As such, processor 112 can execute transmission component 120 to transmit email text data A to a first user device and a second user device specified by first tag data. In another aspect, processor 112 can execute transmission component 120 to transmit email text data B, which is different from email text data A, to a second device location that is different from the first device location based on second tag data representing the second device location that is different from the first device location.

In an aspect, transmission component 120 can employ a threading technique that groups various content segments of an email message based on tag data coupled to such content segments. For instance, processor 112 can execute transmission component 120 to group all email content data (e.g., subject line data, email body data, attachment data, header data, etc.) coupled with a respective tag (e.g., @JohnDoe) and transmit such grouped email content data to a destination device in accordance with location information encoded within the tag data. Furthermore, processor 112 can execute transmission component 120 to employ parsing components (e.g., not shown in FIG. 1A) that perform parsing tasks when executed by processor 112. As such, transmission component 120 can facilitate an analysis of email message content by parsing such content into segments. The parsed content segments can also be characterized based on syntactic roles of such content segment. For instance, processor 112 can execute transmission component 120 to determine whether a parsed content segment is a portion of the email content to be transmitted to a group of user devices and therefore should allow for interactive communication (e.g., email reply and reply all functions) capabilities to all such user devices (e.g., addresses, locations associated with such user devices) within the group of user devices.

In another aspect, transmission component 120 can employ threading tasks to determine whether multiple recipient user devices of email message content segments are intended to be part of the same thread. For instance, processor 112 can execute transmission component 120 to employ a system component that executes a probability operation that determines a probability that multiple users belong to the same thread in order to enable group interactive functions. Furthermore, in an aspect, the probability operation can determine that tag data associated with a group of user devices that is coupled to a segment of subject line data has a greater probability of requiring interactive communication functions between the respective group of user devices. As such, subject line data can inform the threading framework of other content segments corresponding to an email message such as message content within the body of the email or included as an attachment. In a non-limiting example, a probability function can determine whether a grouping of respective subsets of tag data are associated with similar content in numerous occasions, the probability of including the respective subsets of tag data and email message content data coupled to such tag data on the same thread increases. Furthermore, the probability function can be employed by associating values to content data subsets and corresponding tag data and comparing such values to threshold values that indicate higher or lower probabilities based on such comparisons.

In another aspect, segments of email message content included within a thread can be assigned respective threading identification data. In an aspect, the threading identification data can be metadata within an email message (e.g., metadata associated with a header portion of an email message). Furthermore, the metadata generated within each outgoing email message within a header can represent threading identification data that are cryptographic hashes. As such, each thread of conversations between respective groups of users can be assigned a cryptographic hash identifier. In an instance, the cryptographic hash identifier can act as a unique digital fingerprint associated with the content corresponding to a thread.

As a non-limiting example, a first email message transmitted by a user device associated with @GeorgeDoe tag data can comprise content segment A coupled to @JohnDoe tag data, @JimDoe tag data, content segment B coupled to @JaneDoe tag data, and content segment C coupled to @JohnDoe, @JimDoe, and @ JaneDoe. In an aspect, the metadata in the header can represent a first cryptographic hash corresponding to content segment A, a second cryptographic hash corresponding to content segment B, and a third cryptographic hash corresponding to content segment C. Accordingly, several threads can be formed, a first thread between a first device associated with @GeorgeDoe, a second device corresponding to @JohnDoe, a third device corresponding to @JimDoe, and a fourth device corresponding to @JaneDoe centered around content segment A. A second thread, can be formed between a first device associated with @GeorgeDoe and a fourth device corresponding to @JaneDoe centered around content segment B. A third thread can be formed between a first device associated with @GeorgeDoe, a second device corresponding to @JohnDoe, a third device corresponding to @JimDoe, and a fourth device corresponding to @JaneDoe centered around content segment C.

As such, the fourth device corresponding to @JaneDoe can receive an email message with content segment B and content segment C and correspond each segment of content to a second cryptographic hash and a third cryptographic has respectively. In another aspect, fourth user device corresponding to @JaneDoe can execute (via one or more processor) a transmission (e.g., using transmission component 120) of a response email comprising content segment D (e.g., transmitted to the first user device of @GeorgeDoe) responsive to content segment B and content segment E (e.g., transmitted to the first user device corresponding to @GeorgeDoe, second user device corresponding to @JohnDoe, and third user device corresponding to @JimDoe) responsive to content segment C with each of content segment E and content segment F corresponding to a fourth cryptographic hash and a fifth cryptographic hash respectively. As such each thread of messages can point back to original content referenced by a string of identification data corresponding to cryptographic hashes. Furthermore, the cryptographic hashes can make the threads tamper proof (e.g., encrypted hashes are secure) and prevent transactions to be incorrectly or artificially added to a thread (e.g., the thread chains can comprise only those email messages that are referenced by the cryptographic hashes).

Therefore, in an aspect, system 100A can execute (e.g., using one or more processor) transmission component 120 to transmit each individual message to one or more user devices based on a determination of which user devices are participants in a thread and based on segments of email message content that are associated with user devices (e.g., represented by tag data) of the thread. Thus, system 100A can employ processor 112 to execute transmission component 120 to transmit a message, each message having a unique identifier (e.g., cryptographic hash) and each message belonging to a unique thread (e.g., expressed as a string of cryptographic hashes that point to one another). Furthermore, the threading identification data can be embedded as metadata to facilitate a user interface that is clean and delivers customized functionality to each user device.

In an aspect, the threading identification data can include cryptographic identification data such as a cryptographic hash comprising pointer data. As such, the pointer data of the cryptographic hash can reference a previous email message and corresponding previous email message content. Therefore, a link can be formed between a chain of email messages to form a thread where the pointer data can point to cryptographic hashes. In an instance, a cryptographic hash can correspond to specific email input (e.g., text data representing sentences within an email message and assigned tag data) and small changes in source email input can result in a calculation of a dramatically different cryptographic hash (e.g., combination of alphanumeric characters and/or symbols). As such, the linking of messages through cryptographic hashes ensure a high degree of confidence that the email messages included in a thread are valid.

At FIG. 1B, illustrated is a diagram of an example, non-limiting graphical user interface (GUI) of an outbound email message capable of segmenting into several email messages in a single send instance. The email message comprises tag data coupled to segments of content data configured for transmission to several recipient devices corresponding to respective addressees in accordance with one or more embodiments described herein. Repetitive description of like elements employed in other embodiments described herein is omitted for sake of brevity.

In an aspect, email message 100B can comprise a set of message content composed within an email where subsets of message content within the email message 100B can be transmitted (e.g., using transmission component 120) to different user devices associated with respective addressees, as different messages based on tag data assigned (e.g., using tagging component 110) to various message segments within the email body. In an aspect, the transmission of multiple messages can occur in a single send instance. In yet another aspect, email message 100B can comprise header 121 comprising TO field 121A, CC field 121B, and BCC field 121C. Furthermore, email message 100B comprises subject field 122, first global content 123, first local content 124, second local content 125, second global content 126, send button 127, and cancel button 128. In another aspect, email message 100B can comprise first addressee 141, second addressee 142, third addressee 143, and fourth addressee 144. In an aspect, subject field 122 has first subject content 145. In another aspect, the message field 146 has message input data and is capable of receiving local and/or global content for transmission.

In an aspect, TO field 121A can receive input data representing email address information associated with an addressee email user account hosted on a networked device (e.g., mail server device, mail exchanger, MX host, network device, etc.) accessible by a user device (e.g., user device 102). In an aspect, the TO field 121A comprises input data related to first addressee 141 represented by the email address Al@MyEmail.com and second addressee 142 represented by Bob@AnotherEmail.com which correspond with a first recipient email account and a second recipient email account respectively. In an aspect, the email address can represent an email box (e.g., email account located on a server) to which an email message (e.g., email message 100B) can be delivered. Furthermore, in an aspect, the email address can represent a local portion (e.g., Al), an at symbol (e.g., @), and a domain (e.g., MyEmail.com) which indicate distinctions between mailbox locations and facilitate a determination of an email account identity. The email message 100B and other email message embodiments can utilize a range of email address formats including email address formats compliant with RFC standards. In another aspect, CC field 121B can also receive email address information associated with an email user account such as third addressee 143 represented by Cindy@MyEmail.com which corresponds with a third recipient email address. In yet another aspect, BCC field 121C can also receive email address information associated with an email user account such as fourth addressee 144 represented by Donna@MyEmail.com.

In an aspect, the TO field 121A can receive input data specifying an addressee configured to receive an email message comprising global message content and/or local message content intended specifically for such addressee. In another aspect, the CC field 121B receives input data specifying other addressee's configured to receive email messages comprising global message content and/or local message content intended specifically for such other addressees. Also, the addressees associated with the data input within TO field 121A and CC field 121B can view email address information corresponding to other addressees within the TO field 121A and CC field 121B but not the BCC field 121C. In another aspect, the BCC field 121C receives input data specifying other addressee's (e.g., other than those specified in TO field 121A and CC field 121B) such as fourth addressee 144. The addressees listed within BCC field 121C are not viewable to the other addressees listed within TO field 121A and CC field 121B recipients.

In another aspect, the subject field 122 can be configured to receive first subject line data 145 corresponding to the subject of the email body. For instance, email message 100B includes first subject line data 145 representing the alphanumeric characters “Meeting at 9 am”. In an aspect, the subject field 122 can be classified as global subject line data in that there is no tag data assigned to the alphanumeric characters. As such, there is no specified local destination information (e.g., addressee information, outbound server location, inbound server location, and/or email account information embedded within the tag data) associated with first subject line data 145, such that transmission component 120 can utilize the destination information corresponding to the addressee data input into TO field 121A, CC field 121B, and BCC field 121C. For instance, first subject line data 145 in subject field 122 can be transmitted (e.g., using transmission component 120) to user device destinations associated with user accounts corresponding to first addressee 141, second addressee 142, third addressee 143, and fourth addressee 144. As such, first subject line data 145 can be global content in that such data can be transmitted to all addressees.

In another aspect, first global content 123 within message field 146 comprises the first two lines of text data input reciting, “Hello” and “There is a meeting for everyone at 9 am”. The data input within message field 146 represents the content corresponding to the body of the email message to be received by respective addressees. In an aspect, global content can refer to the absence of tag data in association with input data (e.g., text data, video data, image data, audio data, etc.), thus indicating that such text data input can be transmitted (e.g., using transmission component 120) to all addressee locations specified at header 121. Accordingly, the transmission component 120 can transmit global data to all addressees (e.g., user account locations) referenced in header 121, however, if tag data is assigned (e.g., using tagging component 110) to the text data input, then the transmission component 120 can utilize the at least a portion of the tag data representing a location of fewer than all of the addressees as a destination for transmission of the data instead of performing a default transmission operation to destinations associated with all addressees listed in header 121. In another aspect, second global component 126 comprises two lines of text data input within message field 146 reciting, “Sincerely” and “Sean Supervisor”. Again, since no tag data is assigned to the second global content 126, the two lines of text data input can be transmitted (e.g., using transmission component 120) to all addressees referenced in header 121.

In yet another aspect, first local content 124 assigns first tag data 162 (e.g., @Cindy) to the local input data referencing “Managers stay behind for 10 am follow-up meeting”. In an aspect, the tag data such as first tag data 162 can correspond with an email address and associated destination information. As such, transmission component 120 can transmit local input data to a destination device that facilitates access to an email account (e.g., third addressee 163) associated with tag data (e.g., first tag data 162) such as a user device. Accordingly, in a non-limiting aspect, transmission component 120 can proceed to transmit email message data by transmitting segments of global content data and/or segments of local content data to destinations specified by tag data (local transmission) and/or email address data. Thus, in the absence of tag data transmission component 120 can transmit email message data to destinations associated with addressee's recited in header 121. In another aspect, second local content 125 assigns second tag data 164 (e.g., @Bob) representing text data that recites, “Contractors can leave early at 9:30 am” for transmission to a local destination (e.g., a location associated with second addressee 142). As such, the transmission component 120 can transmit the local input data to a device (e.g., server, user device, etc.) that facilitates access to email account data associated with second addressee 142. In an aspect, the transmission component 120 utilizes destination information specified by tag data (e.g., @Bob) and/or second addressee 142 instead of all the addressees listed within header 121.

In another aspect, second global content 126 represented by input text data that recites, “Sincerely” and “Sean Supervisor” is not coupled with tag data and as such, transmission component 120 can transmit second global content 126 to all addressee destinations referenced in header 121. In another aspect, send button 127 can receive input data to trigger the transmission (e.g., using transmission component 120) of one or more email messages comprising varied combinations of global content segments and local content segments to numerous destinations in a single send instance. Furthermore, various different configurations and segments of the message content can be transmitted to different destinations based on tag data specifications and/or addressee specifications in a single send instance. Similarly, cancel button 128 can receive (e.g., based on a triggering of the cancel button 128) cancellation input data that facilitates a cancellation or stopping of email message transmission (e.g., using transmission component 120) prior to completion of the transmission occurring.

Turning now to FIG. 1C, illustrated is a diagram of an example, non-limiting graphical user interface (GUI) of an inbound email message comprising segments of global content data received by one or more devices associated with a first addressee and a fourth addressee specified in the outbound email message in accordance with one or more embodiments described herein. Repetitive description of like elements employed in other embodiments described herein is omitted for sake of brevity.

In an aspect, email message 100C represents an email message variant received by a device corresponding to an addressee and email account. In an aspect, the email message 100C comprises segments of global content and segments of local content based on tag data within the transmitted email body. In an aspect, email message 100C comprises first recipient header 151 comprising only a TO field 121A and CC field 121B and although an email message may be transmitted to the fourth addressee 144, such fourth addressee 144 and the BCC field 121C is not visible in email message 100C received by first addressee 141. Also, FROM field 152, TO field 121A and CC field 121B are displayed in email message 100C, however, such fields are not capable of receiving input, but rather displaying previously input data from the composed and outgoing email message 100B. Furthermore, in an aspect, email message 100C comprises subject field 122, first global content 123 and second global content 126. In an instance, email message 100C can represent an email message received by first addressee 141 and fourth addressee 144.

In an aspect, the subject field 122 includes first subject line data 145 representing global content (e.g., transmitted to all addressee's) given the absence of tag data assigned to the first subject line data 145. Furthermore, first recipient header 151 does not present the BCC field 121C illustrated in FIG. 1B, such that first addressee 141, second addressee 142, and third addressee 143 are unaware of message recipient fourth addressee 144. As such, first addressee 141 (e.g., Al@MyEmail.com) and second addressee 142 (e.g., Bob@MyEmail.com) were recited in the TO field 121A and therefore do not see the BCC field 121C addressees. In another aspect, third addressee 143 (e.g., Cindy@MyEmail.com) recited in the CC field 121B is presented in received email message 100C. Also, first global content 123 in the body of email message 100C reciting, “There is a meeting for everyone at 9 am” is presented in the received email message 100C given that such first global content 123 has been transmitted to all addressee's listed in header 122 (e.g., illustrated in FIG. 1B) of email message 100B Similarly, second global content 126 reciting “Sincerely” and “Sean Supervisor” is presented in received email message 100C, also because such first global content 123 has been transmitted to all addressee's listed in first recipient header 121 (e.g., illustrated in FIG. 1B) of email message 100B. In yet another aspect, a device corresponding to fourth addressee 144 (e.g., Donna@MyEmail.com) also receives email message 100C and its contents in that such fourth addressee 144 was recited in BCC field 121C illustrated at FIG. 1B.

In an aspect, the segments of content within email message 100C can be received as packets of data originally transmitted from a device corresponding to sender addressee 147 (e.g., Sean@MyEmail.com). As such, a first data packet received by recipient devices corresponding to first addressee 141 and second addressee 142 (e.g., Al@MyEmail.com and Bob@MyEmail.com) respectively can comprise header data corresponding to first recipient header 151. Furthermore, in an aspect, second packet data received by recipient devices can comprise first subject line data 145 corresponding to subject field 122. Also, third packet data received by recipient devices can comprise global content 126 representing input text data. As such, all transmitted data packets can be received at the recipient devices (e.g., devices associated with email accounts and/or addressee locations) and presented (e.g., at user interfaces of the recipient devices) as email message 100C. Furthermore, in an aspect, the packet data can be ordered to form a coherent and chronological email message 100C, such that the header information is located at the top portion of the email message 100C, the subject line data is located below the header information, and the body of the email message content is located at the lower portion of the email message 100C. As such, subsets of packet data can be transmitted (e.g., using transmission component 120) as subsets and assembled into an organizational framework at one or more locations (e.g., outbound server, inbound server, user device, etc.).

In an aspect, email messages such as email message 100B and other email message embodiments disclosed herein can include several features. In an aspect, the email message system can employ a follow up reminder or follow up on reply (FUR) feature to remind an addressee (e.g., via an email account and/or user device) to follow up with a reply to a received email message or transmitted email message. In an aspect, such feature can utilize artificial intelligence features to predict and/or anticipate the need for a response to a received email message. In an aspect the FUR feature can deploy reminder data or notification data for receipt by an addressee to follow up with a reply to a transmitted email message within one or more message thread. Furthermore, in an aspect, email messages can include targeted, personalized, and/or customized advertisements within reminder email notifications (e.g., FUR).

In an instance, a GUI of an outbound email message can include a FUR button (not illustrated) upon the transmission of an email message. As such, a user device can transmit an email message and then input user data to trigger the FUR button to send a follow up email as a reply or reminder to the composed and transmitted email message. In a non-limiting embodiment, a default time frame can be established using settings for all FUR's (e.g., three days). Thus, upon the triggering (e.g., inputting data) of the FUR button, a reminder is emailed to the account according to the default settings (e.g., third day from the original email). In another non-limiting embodiment, a default setting can be established to transmit a FUR to other networks or applications as part of a follow-up to an already transmitted email message. Furthermore, this FUR feature (e.g., pursuant to a triggering of a FUR button) can include a capability to select and/or embed a reminder to transmit a FUR within a calendar application.

In another non-limiting embodiment, calendar data representing a calendar can be displayed at a user interface and a date can be selected based on user input data corresponding to a date a FUR can be scheduled for transmission. In another non-limiting embodiment, the FUR can be transmitted pursuant to an artificial intelligence based mechanism. For example, a bot can be deployed to review an email message or email message thread for the presence of a reply to an originally transmitted email message. If the bot does not recognize the presence of a reply email message, then the bot can transmit a reminder to an addressee to follow up with a reminder to the recipient party to respond to the email message. In yet another aspect, a user device can select and/or delete reminder emails based on an acknowledgement that a follow up email response was received (e.g., cancel). In another aspect, a FUR can be postponed and an additional follow up can be transmitted at a later or postponed date (e.g., a new follow up day or the next day). Also, in an aspect, the original email transmitted can be included in the reminder to check on whether a follow-up email has been transmitted. Furthermore, in an embodiment, the FUR can include a contextual advertisement embedded within the FUR. In yet another embodiment, a separate section can be included to manage or view historical FUR's. Also, a new folder can be created to transmit reminder emails or after a threshold amount of postponements for transmitting FUR's occur, a follow up reminder email notification may be canceled.

At FIG. 1D, illustrated is a diagram of an example, non-limiting graphical user interface (GUI) of an inbound email message comprising segments of global content data and local content data received by one or more devices associated with the third addressee specified in the outbound email message in accordance with one or more embodiments described herein. Repetitive description of like elements employed in other embodiments described herein is omitted for sake of brevity.

In an aspect, email message 100D comprises a set of message content where subsets of message content within the email message can be received by a device associated with a respective addressee and where the email message contents comprise global content data and local content data coupled (e.g., using tagging component 110) to tag data within the transmitted (e.g., using transmission component 120) email message 100D. In an aspect, email message 100D comprises first recipient header 151 comprising TO field 121A and CC field 121B. Furthermore, email message 100D comprises subject field 122, first global content 123, first received local content 124A and second global content 126. In an instance, email message 100D can represent a email message received by third addressee 143 (e.g., Cindy@MyEmail.com). In an aspect, the device corresponding to third addressee 143 can receive data packets associated with the general (e.g., global) elements and the specific (e.g., local) elements of composed email message 100B. As such, local content assigned first tag data 162 (e.g., @Cindy) specifying the destination corresponding to third addressee 143 can be transmitted (e.g., using transmission component 120) from sender addressee 147 to third addressee 143.

In an aspect, subject field 122 includes first subject line data 145 that is global content (e.g., transmitted to all addressee's) given the absence of assigned tag data corresponding to subject line data 145. Furthermore, first recipient header 151 does not include the addressee's recited in BCC field 121C as previously illustrated in FIG. 1B. As such, third addressee 143 (e.g., Cindy@MyEmail.com) was recited in the CC field 121B and does not view a display of the BCC field 121C and associated addressees within email message 100D. Also, first global content 123 in the body of the email message 100D reciting “There is a meeting for everyone at 9 am” is presented in the received email message 100D given that such first global content 123 has been transmitted to all addressee's listed in header 121 of email message 100B. Similarly, second global content 126 reciting “Sincerely” and “Sean Supervisor” is displayed in the received email message 100D because such first global content 123 has been transmitted to all addressee's listed in header 121 of email message 100B.

In yet another aspect, first local content 124 reciting “Managers stay behind for 10 am follow-up meeting” was assigned (e.g., using tagging component 120) first tag data 162 (e.g., @Cindy) corresponding to third addressee 143 in email message 100B and is thus only received by a device corresponding to or accessible by third addressee 143 and presented in email message 100D. For instance, first received local content 124A is presented in received email message 100D and such text representation does not include display the first tag data 162 (e.g., @Cindy). As such, the tag data is utilized in outbound messages for instructional and operational purposes, but not to be visually displayed in a received email. Furthermore, the targeted destination information represented by the tag data supersedes the default instructions to transmit the local message content to all of the addressees recited in header 121 of email message 100B. In yet another aspect, the tag data can be linked to segments of email address information and/or destination information recited in header 121. For instance, tag data corresponding to the first tag data 162 can correspond to the addressee location information represented by Cindy@MyEmail.com. In another aspect, the tag data can convey color coding information such that data intended for each particular addressee can be displayed in a different color. For instance, conversations specific to first addressee 141 can appear in yellow colored text, second addressee 142 can appear in blue colored text, third addressee 143 can appear in green colored text, and fourth addressee 144 can appear in pink colored text.

In an aspect, the segments of content within email message 100D can be received as packets of data originally transmitted from a device corresponding to sender addressee 147 (e.g., Sean@MyEmail.com). As such, a first data packet received by a recipient device corresponding to third addressee 143 (e.g., Cindy@MyEmail.com) can comprise header data corresponding to header 121D. Furthermore, in an aspect, second packet data received by recipient devices can comprise first subject line data 145 corresponding to subject field 122. Also, third packet data received by recipient user devices can comprise email message content data corresponding to second global content 126 and first local content 124 (e.g., specifically designated for third addressee 143). As such, all transmitted data packets can be received at the recipient devices and presented (e.g., at user interfaces of the recipient devices) as email message 100D. Furthermore, the packet data can be ordered to form a coherent and chronological email message 100D, such that the header information is located at the top portion of the email message 100D, the subject line data is located below the header information, and the body of the email message content is located at the lower portion of the email message 100D.

At FIG. 1E, illustrated is a diagram of an example, non-limiting graphical user interface (GUI) of an inbound email message comprising segments of global content data and local content data received by one or more devices associated with the second addressee specified in the outbound email message in accordance with one or more embodiments described herein. Repetitive description of like elements employed in other embodiments described herein is omitted for sake of brevity.

In an aspect, email message 100E comprises a set of message content within an email message where subsets of message content within the email message can be received by a device associated with an addressee and where the email message contents are based on a transmission (e.g., using transmission component 120) of global content data and local content data corresponding to tag data assigned (e.g., using tagging component 110) within the transmitted email body. In an aspect, email message 100E comprises first recipient header 151 comprising TO field 121A and CC field 121B. Furthermore, email message 100E comprises subject field 122, first global content 123, second received local content 125A, and second global content 126. In an instance, email message 100E can represent an email message received by a device associated with or accessible by second addressee 142 (e.g., Bob@MyEmail.com). In an aspect, the device corresponding to second addressee 142 receives the data packets associated with the general elements of the composed email message 100B and the specific elements of the composed email message 100B specifically designated for the device corresponding to second addressee 142.

In an aspect, the subject field 122 includes first subject line data 145 that is global content (e.g., transmitted to all addressee's) due to the absence of assigned tag data corresponding to first subject line data 145. Furthermore, first recipient header 151 does not include the addressee's recited in the BCC field 121C as previously illustrated in FIG. 1B. Also, in an aspect, first global content 123 in the body of the email message reciting, “There is a meeting for everyone at 9 am” is presented in the received email message 100E given that such first global content 123 has been transmitted to all addressee's listed in header 122 of email message 100B. Similarly, second global content 126 reciting “Sincerely” and “Sean Supervisor” is presented in the received email message 100E because such first global content 123 has been transmitted to all addressee's listed in header 121 of email message 100B. In yet another aspect, second received local content 125A reciting, “Contractors can leave early at 9:30 am” was assigned (e.g., using tagging component 120) to second tag data 164 (e.g., @Bob) targeting second addressee 142 in email message 100B and is thus received only by a device corresponding to or accessible by second addressee 142. As such, second received local content 125A is displayed in email message 100E delivered to second addressee 142. As such, the destination information represented by second tag data 164 takes priority over the entirety of addressee data recited in header 121 of email message 100B. In yet another aspect, the tag data can be linked to segments of email address information and/or destination information recited in header 121. For instance, second tag data 164 (e.g., @Bob) can correspond to the addressee location information represented by second addressee 142 referred to as Bob@MyEmail.com.

In an aspect, the segments of content within email message 100E can be received as packets of data originally transmitted from a user device corresponding to sender addressee 147 (e.g., Sean@MyEmail.com). As such, a first data packet received by a recipient device corresponding to or accessible by second addressee 142 (e.g., Bob@MyEmail.com) can comprise header data corresponding to header 121 of email message 100B. Furthermore, in an aspect, second packet data received by recipient devices can comprise subject line data 145 corresponding to subject field 122. Also, third packet data received by recipient devices can comprise input data corresponding to second global content 126, first global content 123, and second received local content 125A (e.g., specifically designated for Bob@MyEmail.com). As such, all transmitted data packets can be received at the recipient user devices (e.g., devices associated with second addressee 142) and presented (e.g., at user interfaces of recipient devices) as email message 100E. Furthermore, the packet data can be ordered to form a coherent and chronological email message 100E, such that the header information is located at the top portion of the email message 100E, the subject line data 145 is located below the header information, and the body of the email message content is located at the lower portion of the email message 100E.

Turning now to FIG. 1F illustrates a diagram of an example, non-limiting graphical user interface (GUI) of an outbound email message capable of segmenting into several email messages in a single send instance. The email message comprises segments of global content and local content within the subject field and the message field for transmission to several recipient devices corresponding to respective addressees in accordance with one or more embodiments described herein. Repetitive description of like elements employed in other embodiments described herein is omitted for sake of brevity.

In an aspect, sender email message 100F comprises a set of message content where subsets of message content within email message 100F can be received by a device associated with an addressee and where the email message contents are based on a transmission (e.g., using transmission component 120) of global content data and local content data corresponding to tag data assigned (e.g., using tagging component 110) within the transmitted email body. In an aspect, email message 100F comprises header 121 comprising TO field 121A, CC field 121B, and BCC field 121C. Furthermore, email message 100F comprises subject field 122, first global content 123, first local content 124, second local content 125, second global content 126, third local content 163, fourth local content 165, third global content 161, send button 127, cancel button 128, first tag data 162, second tag data 164, message field 146, first addressee 141, second addressee 142, third addressee 143, and fourth addressee 144.

In an aspect, similar to email message 100B, TO field 121A can receive email address information associated with an email user account hosted on a networked device (e.g., server device, user device, network device, etc.) or accessible by a device (e.g., user device 102). In an aspect, the TO field 121A comprises input data including first addressee 141 input data (e.g., Al@MyEmail.com) and second addressee 142 input data (e.g., Bob@AnotherEmail.com), which correspond with a first recipient email address and a second recipient email address respectively. In another aspect, CC field 121B can also receive email address information associated with an email user account and comprises third addressee 163 input data (e.g., Cindy@MyEmail.com), which corresponds with a third recipient email address. In yet another aspect, BCC field 121C can also receive email address information associated with an email user account and comprises fourth addressee 144 input data (e.g., Donna@MyEmail.com). In an aspect, the TO field 121A receives input data specifying an addressee intended to receive an email message, the CC field 121B receives input data specifying other addressee's related to the email message, the BCC field 121C receives input data specifying other addressee's (e.g., other than those specified in TO field 121A and CC field 121B) related to the email message but not shown to the other recipients (e.g., TO field 121A and CC field 121B recipients).

In another aspect, the subject field 122A receives subject line data including third global content 161, third local content 163, and fourth local content 165 that can be descriptive of the subject of the content within the email body. For instance, third global content 161 can represent the alphanumeric characters “Meeting at 9 am” and such subject line data is not coupled to any tag data such that third global content 165 can be transmitted to all addressees listed within header 121. Furthermore, third local content 163 can represent the alphanumeric characters “Meeting at 10 am” and such local content is assigned (e.g., using tagging component 110) to first tag data 162 (e.g., @Cindy) indicating that third local content 163 is instructed to only be transmitted (e.g., using transmission component 120) to a device corresponding to third addressee 143 (e.g., Cindy@MyEmail.com). In another aspect, fourth local content 165 is assigned to second tag data 164 (e.g., @Bob) indicating that fourth local content 165 is instructed to be transmitted to a device corresponding to second addressee 142 (e.g., Bob@MyEmail.com). As such, the specific portions of content including first local content 124, second local content 125, third local content 163, and fourth local content 165 can be transmitted (e.g., using transmission component 120) directly a corresponding recipient addressee as designated by the tag data assigned to respective segments of local content.

For instance, the textual input of third local content 163 reciting, “Meeting at 10 am” and third local content 163 reciting, “Managers stay behind for 10 am follow-up meeting” in the body of the email can be transmitted only to a device corresponding to third addressee 143 (e.g., Cindy@MyEmail.com). Furthermore, the textual input data of fourth local content 165 reciting, “Finish at 9:30 am” and the textual input data of second local content 125 reciting, “Contractors can leave early at 9:30 am” in the body of the email can be transmitted only to second addressee 142 (e.g., Bob@MyEmail.com). Furthermore, in an aspect, third global content 161 can be considered global content in that there is no tag data assigned to the alphanumeric characters. As such, there is no specified targeted destination information (e.g., within the tag data) associated with third global content 161 reciting, “Meeting at 9 am”, such that transmission component 120 can transmit such subject line data to first addressee 141, second addressee 142, third addressee 143, and fourth addressee 144 within TO field 121A, CC field 121B, and BCC field 121C. For instance, the subject line data in subject field 122 can be transmitted (e.g., using transmission component 120) to device destinations and/or email account devices associated with first addressee 141, second addressee 142, third addressee 143, and fourth addressee 144.

In another aspect, first global content 123 references the first two lines of text data input within the body of the email message reciting, “Hello” and “There is a meeting for everyone at 9 am”. In an aspect, first global content 123 can be considered global content in that no overriding tag data is assigned to the references two lines of text data input, thus indicating that such text data input can be transmitted to all addressees within the fields of header 121. Accordingly, the transmission component 120 can transmit data (e.g., global data) to all addressee destination locations referenced in header 121 as opposed to local data assigned to tag data, in which transmission component 120 can transmit such local data only to the destination location specified by the tag data. In another aspect, second global component 126 references the first two lines of text data input within the body of the email message reciting, “Sincerely” and “Sean Supervisor”. Again, since no tag data is assigned to the second global content 126, the two lines of text data input will be transmitted (e.g., using transmission component 120) to all addressees referenced in header 121.

Turning now to FIG. 1G, illustrated is a diagram of an example, non-limiting graphical user interface (GUI) of an inbound email message comprising segments of global content data received by one or more devices associated with the first addressee and fourth addressee specified in the outbound email message in accordance with one or more embodiments described herein. Repetitive description of like elements employed in other embodiments described herein is omitted for sake of brevity.

In an aspect, email message 100G comprises a set of message content where subsets of message content can be received by a device associated with an addressee and where the email message contents are based on a transmission (e.g., using transmission component 120) of global content data and local content data corresponding to tag data assigned (e.g., using tagging component 110) within the transmitted email body. In an aspect, email message 100G comprises header 121D comprising TO field 121A and CC field 121B. Furthermore, email message 100G comprises subject field 122, first global content 123 and second global content 126. In an instance, email message 100G can represent an email message received by addressee user devices corresponding to first addressee 141 and second addressee 142 (e.g., Al@MyEmail.com and Donna@MyEmail.com).

In an aspect, email message 100F (e.g., illustrated in FIG. 1F) represents an email message composed by sender addressee 147. Furthermore, email message 100F is configured to deliver (e.g., using transmission component 120) first global content 123, second global content 126, and third global content 161 to devices corresponding to first addressee 141, second addressee 142, third addressee 143, and fourth addressee 144 recited in header 121 (e.g., Al@MyEmail.com, Donna@MyEmail.com, Bob@MyEmail.com, and Cindy@MyEmail.com). In an aspect, email message 100G represents a received message of global content without any local content segments. Accordingly, the email message 100G can be received by first addressee 141 and second addressee 142. As such, the message section of email 100G recites, “Hello: There is a meeting for everyone at 9 am.” and “Sincerely, Sean Supervisor”, which are global message segments because such text data segments are not coupled with tag data (e.g., @Cindy and @Bob). As such, the message section of email 100G can be transmitted (e.g., using transmission component 120) to all addressee data recited in header 121. Furthermore, in an aspect, the subject line data of third global content 161 within subject field 122 recites, “Meeting at 9 am”, which is also a globally directed message segment due to the absence of tag data.

Turning now to FIG. 1H, illustrated is a diagram of an example, non-limiting graphical user interface (GUI) of an inbound email message comprising segments of global content data and local content data received by one or more devices associated with the third addressee specified in the outbound email message in accordance with one or more embodiments described herein. Repetitive description of like elements employed in other embodiments described herein is omitted for sake of brevity.

In an aspect, email message 100H comprises a set of message content where subsets of message content within the email message can be received by a device, associated with third addressee 143 (e.g., Cindy@MyEmail.com) and where the email message contents are based on a transmission (e.g., using transmission component 120) of global content data and local content data corresponding to tag data assigned (e.g., using tagging component 110) within the body of the email. In an aspect, email message 100H includes header 121 comprising FROM field 152, TO field 121A and CC field 121B. Furthermore, email message 100H further includes subject field 122 including third global content 161, third local content 163, first global content 123, second local content 124A, and second global content 126.

In an aspect, the subject line content (e.g., third global content 161) reciting, “Meeting at 9 am” is not assigned tag data and is thus transmitted to all recipient devices recited within header 121. In another aspect, the subject line content (e.g., third local content 163) reciting, “Meeting at 10 am” is coupled to first tag data 162 (e.g., @Cindy) corresponding to third addressee (e.g., Cindy@MyEmail.com) and is only transmitted (e.g., using transmission component 120) to the device associated with first tag data 162. In another aspect, the language reciting, “Managers stay behind for 10 am follow-up meeting” is also coupled to first tag data 162 (e.g., @Cindy) corresponding to the device corresponding to or accessibly by third addressee 143 (e.g., Cindy@MyEmail.com) and is only transmitted (e.g., using transmission component 120) to such device.

Also, the message section of email 100H recites, “Hello: There is a meeting for everyone at 9 am.” (e.g., first global content 123) and “Sincerely, Sean Supervisor” (e.g., second global content 126) are labeled as global composed message segments because they do not have a recipient tag (e.g., @Cindy and @Bob) assigned to such message segments. As such, global message segments are instructed to be received by all addressee's recited in header 121 in email message 100F including the device corresponding to third addressee 143 (e.g., Cindy@MyEmail.com) as shown in email message 100H. Accordingly, email message 100H received by the device associated with third addressee 143 (e.g., Cindy@MyEmail.com) is comprised of local message content and global message content and as such is one of several email message variants transmitted in a single send instance (e.g., receiving input at send button 127) from the device corresponding to sender addressee 147 (e.g., Sean@MyEmail.com).

Turning now to FIG. 1I, illustrated is a diagram of an example, non-limiting graphical user interface (GUI) of an inbound email message comprising segments of global content data and local content data received by one or more devices associated with the second addressee specified in the outbound email message in accordance with one or more embodiments described herein. Repetitive description of like elements employed in other embodiments described herein is omitted for sake of brevity.

In an aspect, email message 100I comprises a set of message content where subsets of message content within the email message can be received by a device, associated with a second addressee 142 (e.g., Bob@MyEmail.com) and where the email message contents are based on a transmission (e.g., using transmission component 120) of global content data and local content data corresponding to second tag data 164 assigned (e.g., using tagging component 110) to segments of content within the transmitted email body. In an aspect, email message 100I comprises header 121 comprising FROM field 152, TO field 121A and CC field 121B. Furthermore, email message 100I comprises subject field 122 including third global content 161, fourth local content 165, first global content 123, second received local content 125A and second global content 126.

In an aspect, the subject line content (e.g., third global content 131) reciting, “Meeting at 9 am” is not assigned tag data and is thus transmitted to all recipient devices corresponding to addressees (e.g., first addressee 141, second addressee 142, third addressee 143 and fourth addressee 144) recited within header 121. Also, in an aspect, the subject line content (e.g., fourth local content 165) reciting, “Finish at 9:30 am” is coupled to second tag data 164 (e.g., @Bob) corresponding to the device of second addressee 142 (e.g., Bob@MyEmail.com) and is only transmitted (e.g., using transmission component 120) to the device associated with second tag data 164. In another aspect, the language reciting, “Contractors can leave early at 9:30 am” is also coupled to second tag data 164 (e.g., @Bob) corresponding to the device of second addressee 142 (e.g., Bob@MyEmail.com) and is only transmitted (e.g., using transmission component 120) to such device. Accordingly, email message 100I received by the device associated with second addressee 142 (e.g., Bob@MyEmail.com) is comprised of local message content and global message content and as such is one of several email message variants transmitted in a single send instance (e.g., receiving input at send button 127) from the device corresponding to sender addressee 147 (e.g., Sean@MyEmail.com).

Also, the message section of email 1001 recites, “Hello: There is a meeting for everyone at 9 am.” (e.g., first global content 123) and “Sincerely, Sean Supervisor” (e.g., second global content 126) are labeled as a general or global composed message segments because they do not have a recipient tag (e.g., first tag data 162 or second tag data 164) assigned to such message segments and such message segments have been received by all addressee's recited in header 121 in email message 100F including the user device corresponding to Bob@MyEmail.com as shown in email message 100I. Accordingly, email message 1001 received by the device associated with second addressee 142 (e.g., Bob@MyEmail.com) is comprised of local message content and global message content and as such is one of several email message variants transmitted in a single send instance (e.g., receiving input at send button 127) from the device corresponding to sender addressee 147 (e.g., Sean@MyEmail.com).

Turning now to FIG. 1J, illustrated is a diagram of an example, non-limiting graphical user interface (GUI) of an outbound email message capable of segmenting into several email messages in a single send instance. The email message comprises segments of global content and local content within the subject field and the message field for receipt at different respective timings by several recipient devices corresponding to respective addressees in accordance with one or more embodiments described herein. Repetitive description of like elements employed in other embodiments described herein is omitted for sake of brevity.

In an aspect, composed email message 100J comprises a set of message content within the email message that can be received by a device associated with first addressee 141, second addressee 142, third addressee 143, and fourth addressee 144 (e.g., Al@MyEmail.com, Bob@MyEmail.com, Dean@OtherEmail.com, Donna@MyEmail.com, Cindy@MyEmail.com, etc.). In an aspect, the email message contents are instructed to transmit (e.g., using transmission component 120) global content data and local content data coupled (e.g., using tagging component 110) with tag data within the transmitted email body. In an aspect, email message 100J includes header 131 comprising TO field 121A, CC field 121B, and BCC field 121C. Furthermore, email message 100F comprises subject field 133, first global content 123, second global content 126, third global content 136, first local message data 134, second local message data 135, third tag data 191, first timing tag data 192, second timing tag data 193, first global subject line data 194, first local subject line data 195, second local subject line data 196, second send button 127, cancel button 128, first tag data 162, second tag data 164, first addressee 141, second addressee 142, third addressee 143, fourth addressee 144, and fifth addressee 189.

In an aspect, similar to email message 100F, email message 100J can utilize TO field 121A can receive email address information associated with a email user account hosted on a networked device (e.g., server device, user device, network device, etc.) accessible by a device (e.g., user device 102). In an aspect, the TO field 121A comprises input data such as first addressee 141 and second addressee 142 (e.g., Al@MyEmail.com and Bob@AnotherEmail.com) which correspond with a first recipient email address and a second recipient email address respectively. In another aspect, CC field 121B can also receive email address information associated with an email user account and comprises input data associated with fifth addressee 189 (e.g., Dean@OtherEmail.com), which corresponds with a third recipient email address. In yet another aspect, BCC field 121C can also receive email address information associated with an email user account and comprises input data (e.g., Donna@MyEmail.com and Cindy@MyEmail.com). In an aspect, the TO field 121A receives input data specifying an addressee intended to receive an email message, the CC field 121B receives input data specifying other addressee's related to the email message, the BCC field 121C receives input data specifying other addressee's (e.g., other than those specified in TO field 121A and CC field 121B) related to the email message but not shown to the other recipients (e.g., TO field 121A and CC field 121B recipients).

In another aspect, the subject field 133 receives subject line data that can be descriptive of the subject of the content within the email body. For instance, email message 100J includes first global subject line data 194 representing the alphanumeric characters “Meeting Today” and such first global subject line data 194 is not coupled to tag data and is therefore instructed for transmission to all addressee's in header 131. In another aspect, the first local subject line data 195 reciting, “at 10 and 11 am” is assigned first tag data 162, third tag data 191, and first timing tag data 192 (e.g., @Cindy @Dean/7:30 EST) indicating that first local subject line data 195 is only directed (and can be transmitted) to devices corresponding to third addressee 143 (e.g., Cindy@MyEmail.com) and fifth addressee 189 (e.g., Dean@OtherEmail.com). In an aspect, the tag data comprising the “@” tag followed by tag data comprising a “/” (e.g., forward slash) can represent a destination and time zone specification in which the corresponding message content can be received by a specified (e.g., using tag data) device at a particular time.

For instance, first local subject line data 195 (e.g., local data) reciting, “at 10 and 11 am” can be received by devices corresponding to third addressee 143 and fifth addressee 189 at 7:30 EST as instructed by the associated tag data (e.g., “/7:30 EST). In another instance, first tag data 162, third tag data 191, and third timing tag data 194, “@Cindy @Dean/7:30 AM EST” indicates that devices corresponding to third addressee 143 and fifth addressee 189 only are directed to receive first local message data 134, “Managers stay behind for an 11:00 AM follow-up” and the tag data indicates such message can be received at 7:30 AM Eastern Standard Time (EST) by such devices.

As such, multiple tags can be assigned to the same message content as exemplified by the two destination tag data subsets (e.g., first tag data 162 and third tag data 191) and the time instruction (e.g., first timing data 192, second timing data 193, etc.) tag data populating the subject field 133. Furthermore, in an aspect, another segment of message content data can be received by another device at a different time by assigning (e.g., using tagging component 110) tag data representing a particular timing for the device to receive the message. For instance, although first local subject line data 195 received by third addressee 143 and fifth addressee 189 are targeted for receipt at 7:30 am EST, the device corresponding to second addressee 142 (e.g., Bob@AnotherEmail.com) is instructed to receive second local subject line data 196 representing the message, “ending at 8:30 am” assigned second tag data 164 and second timing data 193 (e.g., @Bob/7:30 MST) such that second local subject line data 196 can be received at 7:30 MST as indicated by the assigned tag data.

In another aspect, the transmission of all message content can occur at the same time including time zone equivalents (e.g., transmission can occur at 6:00 PM EST which is also 5 PM CST, 4 PM MST, and 3:00 PM PST), but control of the receipt (e.g., third addressee 143 can receive a combination of local and global content at 7:30 AM EST and second addressee 142 can receive a combination of local and global content at 7:30 AM MST) of such message based on the timing instructions associated with assigned tag data. As such, the specific portions of content can be transmitted directly to its corresponding recipient addressee as designated by the tag data assigned to such local content. In another aspect, the second local message data 135 reciting, “Bob, you only have 30 minutes to dial-in” can be received at 7:30 AM MST. In another aspect, a device corresponding to fourth addressee 144 and third addressee 143 recited within the BCC field can receive messages and other addressees are not able to view such addressees as receiving and email message content. For instance, portions of subject line data and message data can be transmitted (e.g., using transmission component 120) to device destinations associated with third addressee 143 and fourth addressee 144, however, because such addressees are listed in the BCC field 121C they will not be known to be a recipient of email message 100J to other addressee's listed in the TO field 121A and CC field 121B. Furthermore, email message 100J allows for an addressee (e.g., third addressee 143 and fourth addressee 144) to be blind copied, but also receive specific (e.g., local and global) message content.

In another aspect, first global content 123 references the first two lines of text data input within the body of the email message reciting, “Hello” and “There is a mandatory meeting for everyone at 10 AM EST”. The first global content 123 can be considered global content in that no overriding tag data is assigned to the references two lines of text data input, thus indicating that such text data input can be transmitted to all addressee (e.g., first addressee 141, second addressee 142, third addressee 143, fourth addressee 144, and fifth addressee 189) input received at header 131. Accordingly, the transmission component 120 can transmit data (e.g., global data) to all addressee destination locations referenced in header 131 as opposed to local data assigned to tag data, in which transmission component 120 can transmit such local data only to the destination location specified by the tag data. In another aspect, second global component 126 references two lines of text data input within the body of the email message reciting, “Sincerely” and “Sean Supervisor”. Again, since no tag data is assigned to the second global content 126, the two lines of text data input will be transmitted (e.g., using transmission component 120) to all addressees referenced in header 131. Furthermore, in an aspect, third global content 136 reciting, “Contractors can leave at 8:30 am MST” can be transmitted to all addressees given that no tag data is assigned to such text data.

Turning now to FIG. 1K, illustrated is a diagram of an example, non-limiting system environment 100K configured to facilitate a transmission of global and/or local content segment assortments within a single outbound email message in accordance with one or more embodiments.

In an aspect, system environment 100K comprises system environment A and system environment B. In a non-limiting environment, system environment A and system environment B can be a single environment (as opposed to two independently operated environments) operated by a single operator. In another non-limiting embodiment, system environment A and system environment B can be two independent operating environments. In an aspect, message client 171 (e.g., user device 102) can employ one or more processor (e.g., processor 112) to execute a transmission component 120 to transmit a message to message application server 172. In an aspect, message application server 172 can be a mail user agent (MUA) employed to receive data transmissions from a front facing graphical user interface (GUI) for a message client 171. In another aspect, message application server 171 can receive transmitted messages from message client 171 in various data formats (e.g., raw text, HTML formatted text, EGM JSON format, etc.). Also, in an aspect, respective lines of text in a composed message transmitted from message client 171 to message application server 172 can comprise plain text, a line to begin with a particular control character (e.g., @, !, #, etc.). For instance, an “@” symbol can be characterized to designate a delivery of a tagged line of text to a specific line of text.

In another aspect, message application server 172 can generate a new thread identifier that is cryptographically unique and capable of encrypting a message (e.g., email content) from end to end (e.g., from composition and transmission to receipt by a designated user) and using efficacious transmission techniques such as storing the data at rest. In an aspect, one or more message application server 172 can generate a cryptographically unique message identifier. In another aspect, message application server 172 can scan a message envelope to TO, BCC, CC recipient lists and/or parse a message body for control characters (e.g., @, #, etc.) in order to match such control characters to recipient lists (e.g., to identify the targeted recipient of a content segment. Also, in an aspect, a message envelope can be enhanced with unique thread and message identifiers, client send data, and time data (e.g., time stamp data). In another aspect, message application server 172 can generate multiple messages for SMTP outbound transmission with a new envelope indicating a message identifier, thread identifier and a transmission destination of of a recipient device message service provider.

Furthermore, in an aspect, message application server 172 can transmit message content (e.g., raw email content) to a user database 173 or MTA/MDA server 174. In an aspect, user database 173 can be a data store comprising data associated with user mailboxes such as user name data, user email address data, a host location or identifier for a message mailbox, and other such data. In an aspect, message data (e.g., including multiple emails within a single email composition) can be stored, accessed, and retrieved from user database 173. Furthermore, in an aspect, such message data can comprise thread and/or message identifiers that can be used for tracking outbound message data (e.g., email messages).

In another aspect, MTA/MDA server 174 (e.g., Mail Transfer Agent/Mail Delivery Agent) can receive message data transmitted from user database 173 and/or message application server 172. In an aspect, the MTA/MDA server 174 can process message data transmitted from message client 171 and structure such message data for email specific formats, joining split message from other non-message senders, and/or splitting messages (e.g., splitting an email message into several messages according to content segments coupled to tag data). In yet another aspect, MTA/MDA server 174 can transmit message data to message SMTP server 176 configured to act as an MTA and utilized for transmitting messages over traditional email service networks for transmission to an end user device that can be located at other email addresses. In another aspect, MTA/MDA server 174 can transmit message data to message IMAP server 175 that is configured to act as a mailbox capable of transmitting email messages to message recipients 178. In an aspect IMAP server 175 can be configured to provide a mailbox to third party message senders to be able to send messages to users within system environment A (e.g., with capabilities of message parsing and transmitting multiple varied and differentiated messages within a single send instance). In a non-limiting embodiment, message client 171, message application server 172, user database 173, MTA/MDA server 174, message IMAP server 175, and/or message SMTP server 176 can be integrated with system environment A. In another aspect, system environment B can comprise IMAP server 177 and message recipient 178 (e.g., recipients of email messages.

In another aspect, inbound message data (e.g., reply email messages) can be transmitted to MTA/MDA server 174 which can monitor an IMAP store (e.g., IMAP server 177, message IMAP server 175, etc.) for such inbound messages. In an aspect, MTA/MDA server 174 can monitor inbound message envelopes for headers that identify system environment A identifiers. In the event system environment A identifiers are present, the MTA/MDA server 174 links with the outbound messages in a message store. Furthermore, in an aspect, the reply body of such message can be combined for viewing messages in an MUA (e.g., message IMAP server 175 or message application server 172. In the event that system environment A identifiers are absent, a heuristic matching operation can be performed. Furthermore, in an aspect, a reply message can attach a message thread identifier with each message thus reducing heuristic mistakes that can occur. For instance, each new message can be assigned a cryptographic message identifier that provide an ability to secure individual messages. In an aspect, the illustration in FIG. 1K comprises dotted arrows that can denote the crossing of an application boundary in a non-limiting embodiment. Furthermore, in a non-limiting embodiment, servers and devices with system environment A can be hosted within a first environment and those within system environment B can be hosted within a different second environment. In another non-limiting embodiment, the servers and devices with system environment A and system environment B can also be hosted within a single same environment. In an aspect, a header within such message system can include a customized thread identifier, a customized recipient list identifier, and/or a customized message identifier.

Turning now to FIG. 1L, illustrated is a diagram of an example, non-limiting system environment 100L configured to facilitate a transmission of global and/or local content segment assortments within a single outbound email message in accordance with one or more embodiments. In an aspect, message client 171 can transmit a composition message 179A comprising tagged message content (e.g., msg1, msg2, msg 3) assigned to several different destinations (e.g., @sam, @willy, @mike) to MTA/MDA server 174. Furthermore, in an aspect, MTA/MDA server 174 can transmit a customized message from the single composed message to a first user device 179B (e.g., @sam), second user device 179C (e.g., @willy), third user device 179D (e.g., @mike) In an aspect, first user device 179B can receive first customized message 179E originating from composition message 179A. Also, second user device 179C can receive second customized message 179F originating from composition message 179A. In another aspect, third user device 179D can receive third customized message 179G originating from composition message 179A. In another aspect, each message can be delivered to a respective user device based on identifier information (e.g., stored in a header of the message) such as a thread ID, recipient list identifier, message identifier).

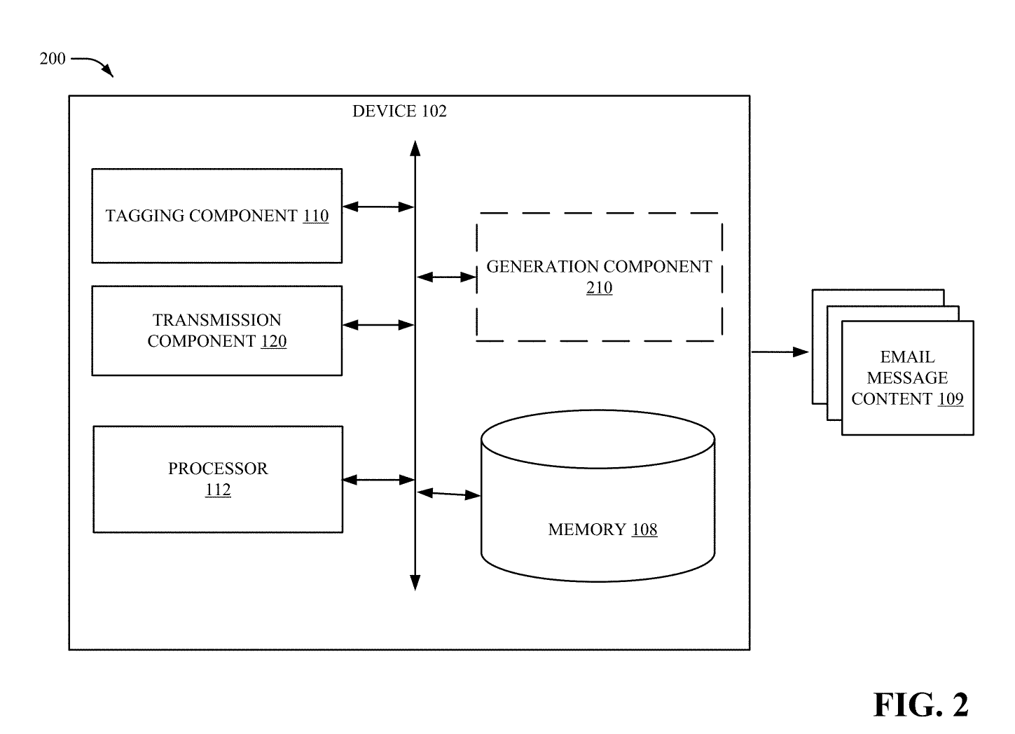

Turning now to FIG. 2, illustrated is a block diagram of an example, non-limiting system 200 that can facilitate a generation of several inbound email messages comprising different global and local content segment assortments in connection with a single outbound email message in accordance with one or more embodiments described herein.

In an aspect, system 200 can comprise or otherwise access (via a network) tagging component 110 and transmission component 120 executing on device 102. In an aspect, processor 112 can execute the computer executable components and/or computer instructions stored in memory 108. In an aspect, one or more of the components of system 200 can be electrically and/or communicatively coupled to one or more devices of system 200 or other embodiments to perform one or more functions described herein.

In an aspect, system 200 can access a storage element (e.g., memory 108) of device 102 and execute (e.g., using processor 112) a tagging component 110 that can assign a set of tag data to a set of content data within a message, wherein a first subset of tag data is assigned to a first subset of content data and a second subset of tag data is assigned to a second subset of content data. In another aspect, system 200 can further comprise a generation component 210 that generates the first subset of content data at the first device and the second subset of data at the second device. In an aspect, generation component 210 can access instructions stored in memory 108 and processor 112 can execute generation component 210 to organize and assemble transmitted content segments to form an inbound email message at a device corresponding to a respective addressee.

For instance, generation component 210 can generate an email message 100I (e.g., illustrated in FIG. 1I) from global content segments and local content segments associated with outbound email message 100F (e.g., illustrated in FIG. 1F) at a device location associated with second addressee (illustrated in FIG. 1F). As such, generation component 210 can generate an inbound email message by ordering and assembling and assembling content for header 121, for subject field 122D, and for message field 146. For instance, generation component 120 can generate header data comprising addressee information from TO field 121A and CC field 121B, but leave out BCC field 121C and corresponding addressee information given that generation component 210, in such instance, is specifically generating an email message for second addressee 142. Furthermore, generation component 210 can utilize ordering data and identification data to identify that such message is an inbound message and as such, header 121 requires a FROM field 152 and corresponding sender addressee information within the generated inbound email. Accordingly, generation component 210 can generate an ordered email message utilizing data packets corresponding to global content segments and local segments. Furthermore, generation component 210 can utilize ordering data, categorical data, identification data, and other such data subsets to properly organize and generate a cohesive, targeted and customized email message for each intended recipient corresponding to an outbound email message (e.g., targeted email messages 109).

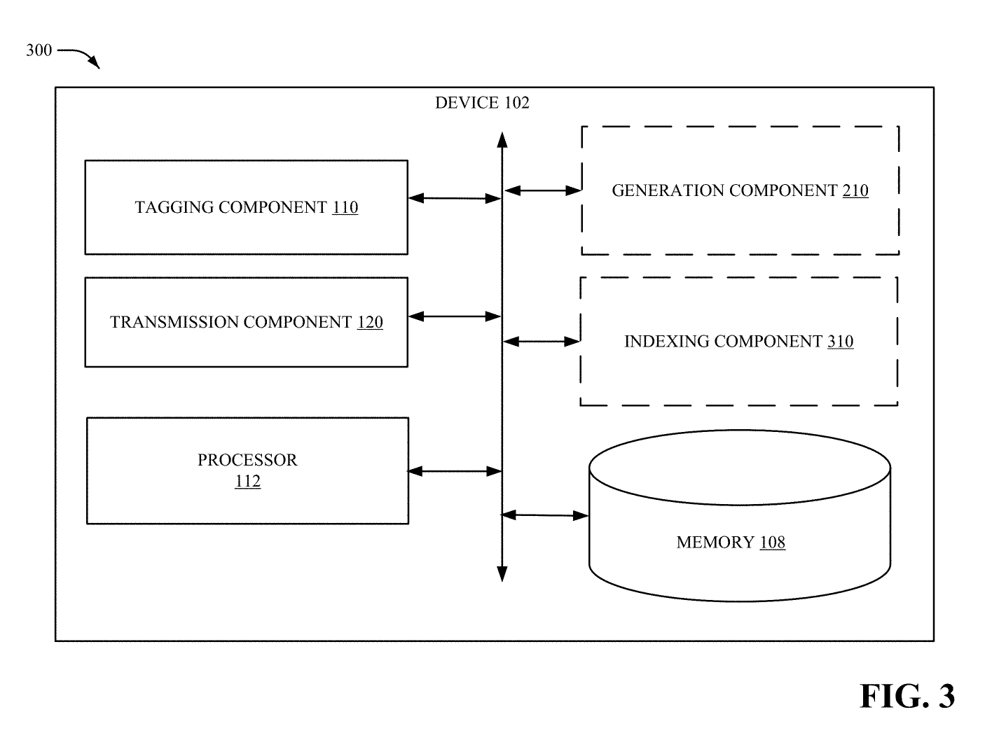

Turning now to FIG. 3, illustrated is a block diagram of an example, non-limiting system 300 that can facilitate a transmission of different content segments within a single message to different recipients in a single send instance in accordance with one or more embodiments described herein. Repetitive description of like elements employed in other embodiments described herein is omitted for sake of brevity.

In an aspect, system 300 can comprise or otherwise access (via a network) tagging component 110, transmission component 120, and generation component 210 executing on device 102. In an aspect, processor 112 can execute the computer executable components and/or computer instructions stored in memory 108. In an aspect, one or more of the components of system 300 can be electrically and/or communicatively coupled to one or more devices of system 300 or other embodiments to perform one or more functions described herein.

In an aspect, system 300 can access a storage element (e.g., memory 108) of device 102 and execute (e.g., using processor 112) a tagging component 110 that can assign a set of tag data to a set of content data within a message, wherein a first subset of tag data is assigned to a first subset of content data and a second subset of tag data is assigned to a second subset of content data. In another aspect, system 300 can further comprise indexing component 310 that stores the first subset of content data, the second subset of content data, the first subset of tag data and the second subset of tag data at one or more data store in accordance with a tag-based organizational framework. In an aspect, indexing component 310 can access instructions stored in memory 108 and processor 112 can execute indexing component 310 to store the first subset of content data, the second subset of content data, the first subset of tag data and the second subset of tag data at one or more data store in accordance with a tag-based organizational framework.

In an instance, indexing component 310 can collect, parse, and store data in a manner that facilitates expedient and accurate retrieval of such data. In an aspect, indexing component 310 can base its indexing capabilities on a variety of factors including, but not limited to merge factors (e.g., how data enters an indexing storage device, how to merge new data into indexes, how to correlate data within an index storage device, etc.), storage techniques (e.g., storing compressed data, filtered data, tagged data, etc.), sizing of an index (e.g., determining storage support for indexing operations, e.g., storing over a blockchain network, distributing storage over a cloud-based network environment, etc.), lookup speed (e.g., how quickly a content segment can be retrieved to generate an email), maintenance factors, index reliability factors (e.g., working on index corruption issues, bad data issues, bad hardware, partitioning schemes such as hash-based identification techniques, and other such factors.

In an aspect, indexing component 310 can utilize store content segments within an indexing architecture based on a tagging framework. For instance, segments of local content coupled to a tag corresponding to the first addressee can be stored at a device (e.g., outbound server, inbound server, etc.) location with other segments of content coupled to tags corresponding to the first addressee. Furthermore, in an instance, global content (e.g., content lacking tag data) can be stored at a separate device such that such data can be retrieved for use in generating (e.g., using generation component 210) global portions of email messages targeted to all addressees. Accordingly, indexing component 310 can utilize various storage mechanisms and techniques to facilitate an efficient and accurate transmission (e.g., using transmission component 120) and/or generation (e.g., using generation component 210) or targeted email messages 109 to various addressees.

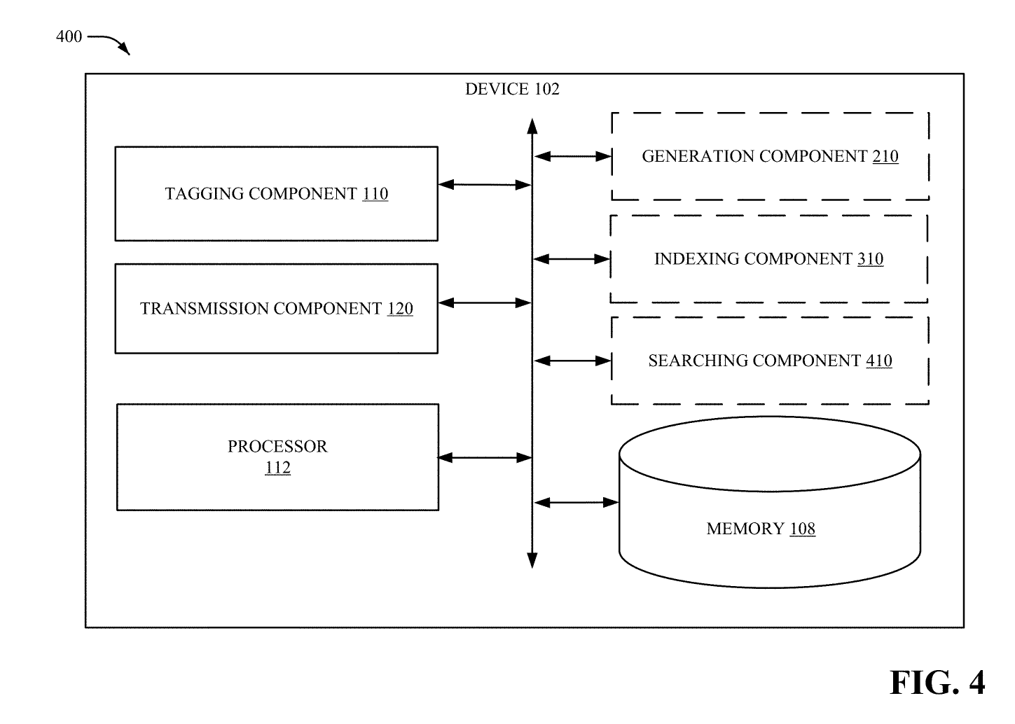

Turning now to FIG. 4, illustrated is a block diagram of an example, non-limiting system 400 that can facilitate a retrieval of segments of global content data and local content data in accordance with one or more embodiments described herein. Repetitive description of like elements employed in other embodiments described herein is omitted for sake of brevity.

In an aspect, system 400 can comprise or otherwise access (via a network) tagging component 110, transmission component 120, generation component 210, and/or indexing component 310 executing on device 102. In an aspect, processor 112 can execute the computer executable components and/or computer instructions stored in memory 108. In an aspect, one or more of the components of system 400 can be electrically and/or communicatively coupled to one or more devices of system 400 or other embodiments to perform one or more functions described herein.

In an aspect, system 400 can access a storage element (e.g., memory 108) of device 102 and execute (e.g., using processor 112) a tagging component 110 that can assign a set of tag data to a set of content data within a message, wherein a first subset of tag data is assigned to a first subset of content data and a second subset of tag data is assigned to a second subset of content data. In another aspect, system 400 can further comprise searching component 410 that retrieves the first subset of content data or the second subset of content data based on an identification of the first subset of tag data and the second subset of tag data at one or more data store. In an aspect, searching component 410 can access instructions stored in memory 108 and processor 112 can execute searching component 410 to retrieve segments of global content and local content based on tag data.

In a non-limiting example embodiment, a user device can perform search activities (e.g., using search component 410) to efficiently locate content, documents, media files, and other items of relevance within an email account mailbox. As such, matching documents directed to a particular addressee can be searched based on tag data in an organized and categorical manner to retrieve matching documents quickly. Furthermore, the searching operation (e.g., performed using searching component 410) can utilize information such as a frequency of tag data coupled to message content, proximity of tag data to target phrases, ranking or relevancy of items to a subset of tag data, and other such information. Also, processor 112 can execute searching component 410 to search for message content based on a range of tag data within a set of email messages corresponding to an email account. For instance, tag data utilized for searching operations can include, but is not limited to, time-based tag data (e.g., tags related to receipt time of email messages), destination-based tag data (e.g., email address coupled tag data), hashtag data, cryptographic hashtag data, knowledge tag data, and other such tag data.

In yet another aspect, searching component 410 can also facilitate efficient retrieval operations of content segments within indexed (e.g., using indexing component 310) storage devices utilizing tag-based storage mechanisms.

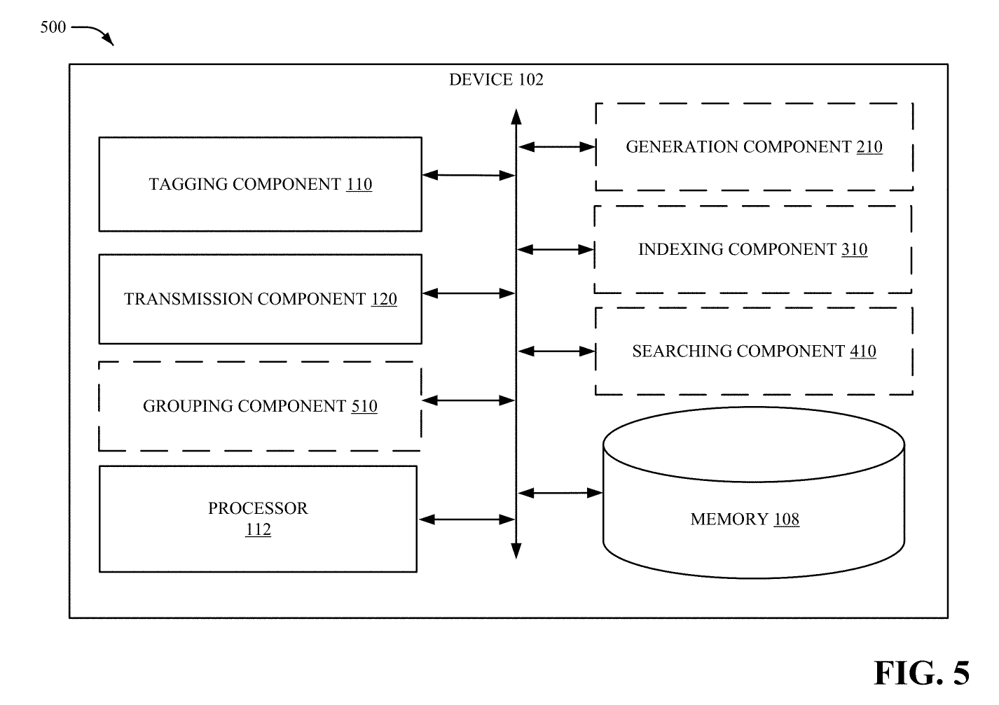

Turning now to FIG. 5, illustrated is a block diagram of an example, non-limiting system 500 that can facilitate a grouping of content segments based on assigned tag data in accordance with one or more embodiments described herein. Repetitive description of like elements employed in other embodiments described herein is omitted for sake of brevity.

In an aspect, system 500 can comprise or otherwise access (via a network) tagging component 110, transmission component 120, generation component 210, indexing component 310, and/or searching component 410 executing on device 102. In an aspect, processor 112 can execute the computer executable components and/or computer instructions stored in memory 108. In an aspect, one or more of the components of system 500 can be electrically and/or communicatively coupled to one or more devices of system 500 or other embodiments to perform one or more functions described herein. In an aspect, system 500 can access a storage element (e.g., memory 108) of device 102 and execute (e.g., using processor 112) a tagging component 110 that can assign a set of tag data to a set of content data within a message, wherein a first subset of tag data is assigned to a first subset of content data and a second subset of tag data is assigned to a second subset of content data. In another aspect, system 500 can further comprise grouping component 510 that group a first portion of the set of tag data and a second portion of the set of tag data into the second subset of tag data for transmission to the first device and the second device respectively based on a data packet switching model.

In an instance, processor 112 can execute grouping component 510 to group content segments into data packets based on tag data similarities. For instance, tag data A associated with local content B and intended for receipt by addressee X at a target time Y can be grouped (e.g., using grouping component 510) into a first data packet for transmission (e.g., using transmission component 120) to an outbound server. Furthermore, tag data B associated with local content C and intended for receipt by addressee X at a target time Z that is different from target time Y can be grouped (e.g., using grouping component 510) into a second data packet for transmission (e.g., using transmission component 120) for transmission to a different outbound server. As such, grouping component 510 can facilitate the transmission of grouped data packets corresponding to content segments within a single composed outbound email into several inbound email messages.

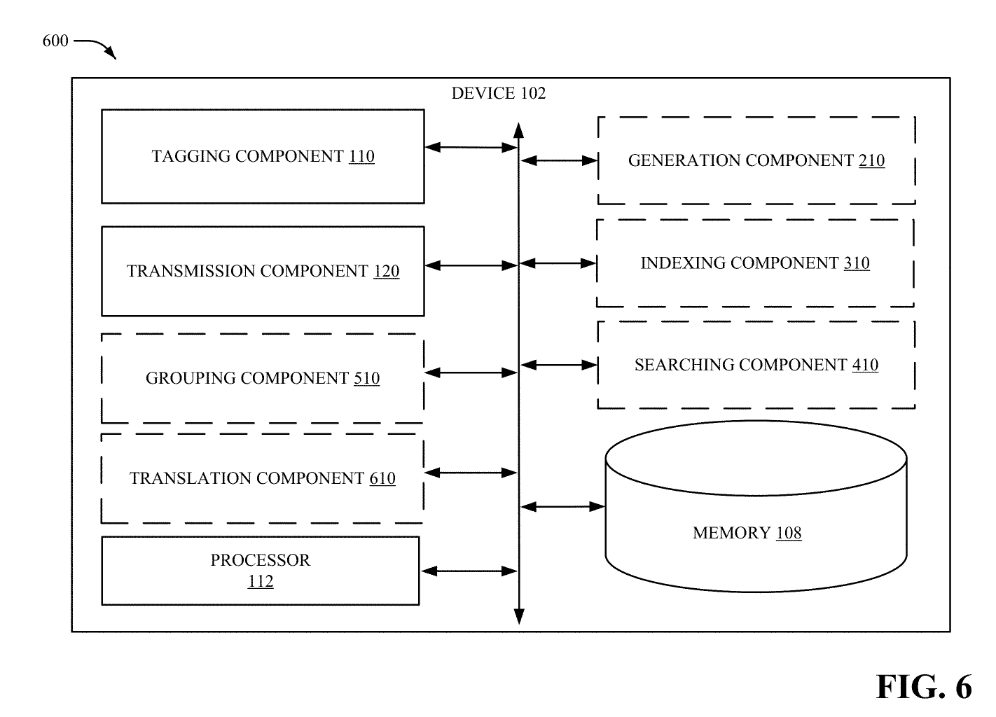

Turning now to FIG. 6, illustrates a block diagram of an example, non-limiting system 600 of the global and local content segments into different languages in accordance with one or more embodiments described herein. Repetitive description of like elements employed in other embodiments described herein is omitted for sake of brevity.

In an aspect, system 600 can comprise or otherwise access (via a network) tagging component 110, transmission component 120, generation component 210, indexing component 310, searching component 410, and/or grouping component 510 executing on device 102. In an aspect, processor 112 can execute the computer executable components and/or computer instructions stored in memory 108. In an aspect, one or more of the components of system 600 can be electrically and/or communicatively coupled to one or more devices of system 600 or other embodiments to perform one or more functions described herein. In an aspect, system 600 can access a storage element (e.g., memory 108) of device 102 and execute (e.g., using processor 112) a tagging component 110 that can assign a set of tag data to a set of content data within a message, wherein a first subset of tag data is assigned to a first subset of content data and a second subset of tag data is assigned to a second subset of content data. In another aspect, system 600 can further comprise translation component 610 that translates the first subset of content data or the second subset of content data from a first language representation to a second language representation based on a correlation between a set of translation data and the first subset of tag data or the second subset of tag data respectively.

In an aspect, processor 112 can execute translation component 610 to allow for the conversion of computer data from a first language format to another language format. In an aspect, content segments within email messages 109 can be encoded based on various standards specifying operations such as data standards and/or file handling. Furthermore, such data can be converted (e.g., using translation component 610 from a first data structure to a second data structure that is different from the first data structure prior to use by a different device, operating system or program. Accordingly, translation component 610 can convert email message content into different formats to be received by various devices such as an outbound server, an inbound server, a user device, and other such devices. In another aspect, translation component 610 can be utilized for purposes of translating targeted content segments to various languages. For instance, tag data A representing a destination corresponding to addressee X and tag data B representing Spanish language conversion data can be coupled (e.g., using tagging component 110) to content segment Y representing text data. Accordingly, content segment Y can be translated (e.g., using translation component 610) into Spanish language text data and be transmitted (e.g., using transmission component 120) to a device corresponding to addressee X. Furthermore, in an aspect, a single composed email can comprise segments of content capable of conversion (e.g., using translation component 610) into several languages.

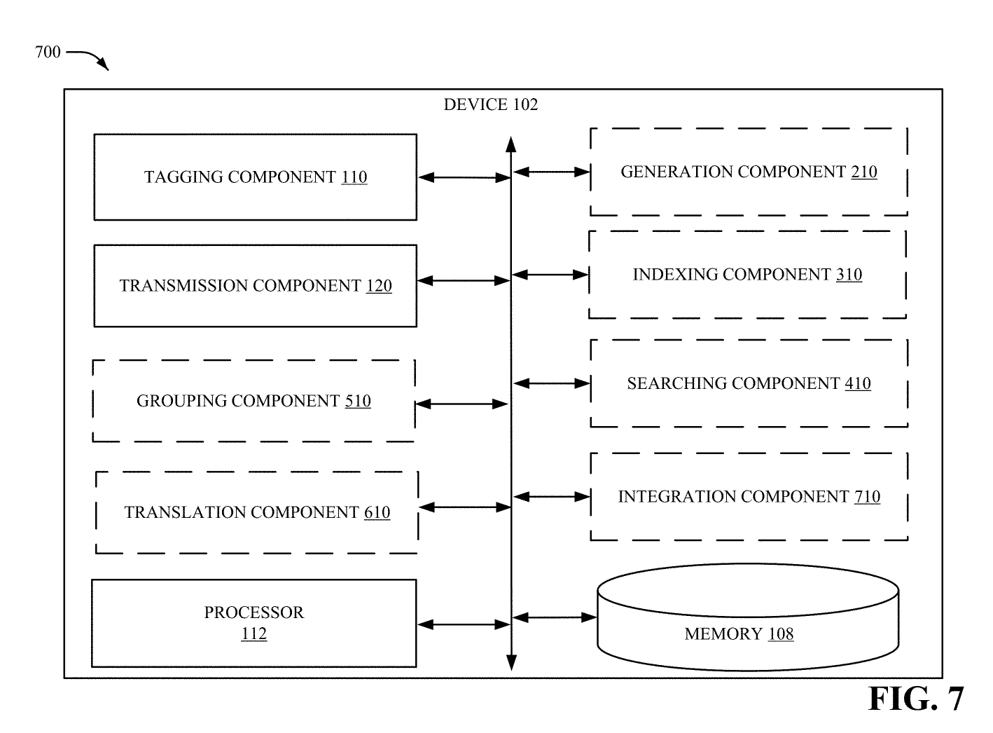

Turning now to FIG. 7, illustrated is a block diagram of an example, non-limiting system 700 that can facilitate an integration of several data points into a segment of content data in accordance with one or more embodiments described herein. Repetitive description of like elements employed in other embodiments described herein is omitted for sake of brevity.

In an aspect, system 700 can comprise or otherwise access (via a network) tagging component 110, transmission component 120, generation component 210, indexing component 310, searching component 410, grouping component 510, and/or translation component 610 executing on device 102. In an aspect, processor 112 can execute the computer executable components and/or computer instructions stored in memory 108. In an aspect, one or more of the components of system 700 can be electrically and/or communicatively coupled to one or more devices of system 700 or other embodiments to perform one or more functions described herein. In an aspect, system 700 can access a storage element (e.g., memory 108) of device 102 and execute (e.g., using processor 112) a tagging component 110 that can assign a set of tag data to a set of content data within a message, wherein a first subset of tag data is assigned to a first subset of content data and a second subset of tag data is assigned to a second subset of content data. In another aspect, system 700 can further comprise an integration component 710 that integrates several data points representing at least two of video data, audio data, image data, or text data into the first subset of content data for transmission as an interoperable data packet based on the first subset of tag data.

In an aspect, processor 112 can execute integration component 710 to integrate (e.g., embed) data subsets within an email message (e.g., email message 109). In an aspect, the data subsets can include items such as media content items including video files, image files, audio filed, text files and other such content. Accordingly, a composed outbound email message can comprise several data subsets coupled to tag data and directed to different destination devices corresponding to different addressees. For instance, email message A can include video file X coupled to destination tag data G associated with a first destination and video file Y coupled to destination tag data H associated with a second destination that is different that the first destination. Thus, integration component 710 can integrate several data subsets representing multiple data types that can be directed for transmission to different destinations corresponding to different addressees.

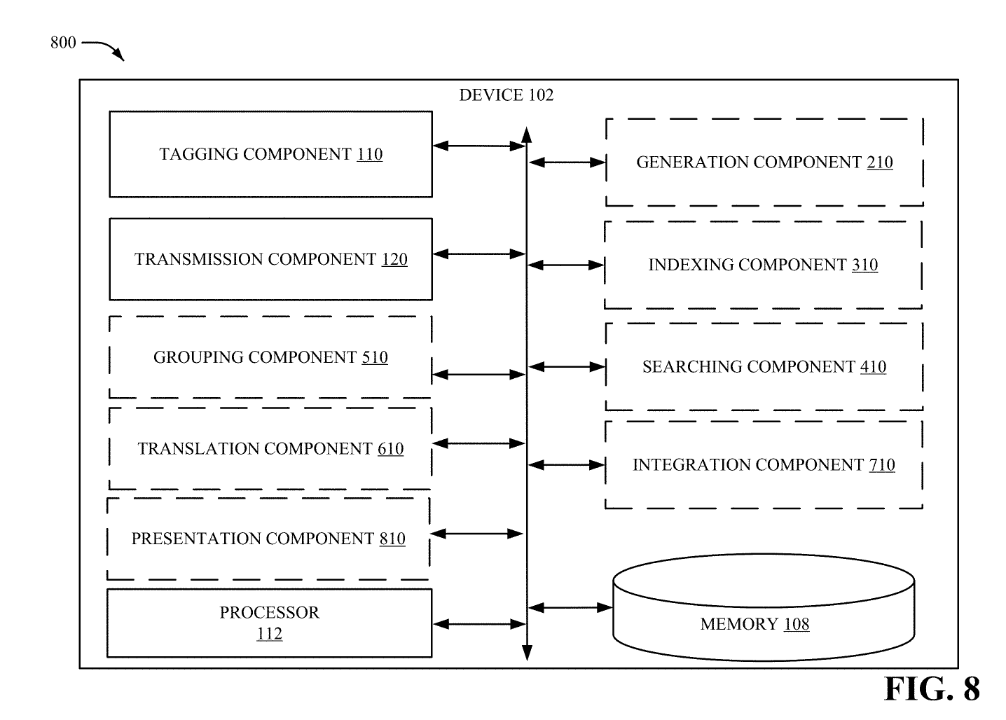

Turning now to FIG. 8, illustrated is a block diagram of an example, non-limiting system that can facilitate a transmission of global content and local content within sharing platforms in accordance with one or more embodiments described herein. Repetitive description of like elements employed in other embodiments described herein is omitted for sake of brevity.

In an aspect, system 800 can comprise or otherwise access (via a network) tagging component 110, transmission component 120, generation component 210, indexing component 310, searching component 410, grouping component 510, translation component 610, and/or translation component 710 executing on device 102. In an aspect, processor 112 can execute the computer executable components and/or computer instructions stored in memory 108. In an aspect, one or more of the components of system 800 can be electrically and/or communicatively coupled to one or more devices of system 800 or other embodiments to perform one or more functions described herein. In an aspect, system 800 can access a storage element (e.g., memory 108) of device 102 and execute (e.g., using processor 112) a tagging component 110 that can assign a set of tag data to a set of content data within a message, wherein a first subset of tag data is assigned to a first subset of content data and a second subset of tag data is assigned to a second subset of content data. In another aspect, system 800 can further comprise a presentation component 810 that transmits the first subset of content data to a first content sharing platform and the second subset of content data to a second content sharing platform based on a third subset of tag data and a fourth subset of tag data respectively, wherein the third subset of tag data and the fourth subset of tag data represent mapping information to locations associated with the first content sharing platform and the second content sharing platform.

In an aspect, processor 112 can execute presentation component 810 to allow for the transmission of segments of local and global content data on message based platforms that include social sharing platforms. In an instance, the presentation component can allow for the tagging of content, objects and/or elements within content shared on such platform and the ability to send any portions, segments, or variants of a single message over such platform. Furthermore, presentation component 810 in connection with translation component 610 can allow one or more devices to access such message variants on one or more device requiring different data formats. In another aspect, presentation component 810 can allow for segments of message content within a single composed message to be transmitted to different destinations (e.g., destination devices) based on tag data as well as various social platform attributes in such as user preferences, social weights of users within a social circle, a social value attribute ascribed to a user, a popularity of a tagged item, variants of media content such as streamable media (e.g., video, live video, video advertisements, music, music videos, sound files, etc.) or static media (e.g., pictures, thumbnails), and other such social platform attributes. As such, presentation component 810 allows for the disclosed messaging systems to be utilized by several messaging platforms in addition to email message systems.

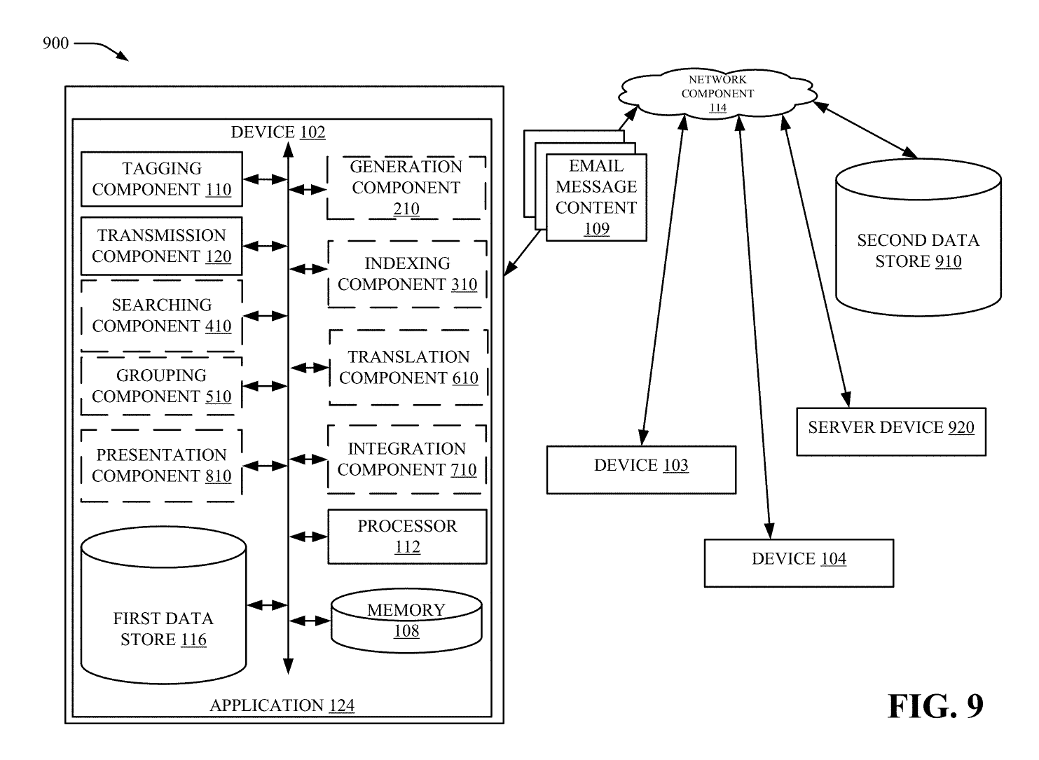

Turning now to FIG. 9, illustrated is a block diagram of an example, non-limiting system 900 facilitate a transmission of email messages to several user devices via a networked system architecture in accordance with one or more embodiments described herein. Repetitive description of like elements employed in other embodiments described herein is omitted for sake of brevity.

In an aspect, system 900 can comprise or otherwise access (via a network) tagging component 110, transmission component 120, generation component 210, indexing component 310, searching component 410, grouping component 510, translation component 610, translation component 710, and/or presentation component 810 executing on device 102. In an aspect, processor 112 can execute the computer executable components and/or computer instructions stored in memory 108. In an aspect, one or more of the components of system 900 can be electrically and/or communicatively coupled to one or more devices of system 900 or other embodiments to perform one or more functions described herein. In an aspect, system 900 can access a storage element (e.g., memory 108) of device 102 and execute (e.g., using processor 112) a tagging component 110 that can assign a set of tag data to a set of content data within a message, wherein a first subset of tag data is assigned to a first subset of content data and a second subset of tag data is assigned to a second subset of content data. In another aspect, system 800 can further comprise a networked architecture that distributes several targeted email message content 109 variants to several devices using a cloud based system architecture.

In an aspect, email message content 109 variants can be transmitted (e.g., using transmission component 120) over a network 114 (e.g., internet, intranet, etc.) to any one or more devices (e.g., device 103, device 104, server device 920, second data store 910). In an aspect, the devices can include an outbound server device, an inbound server device, a mailbox server device, a data store, a user device (e.g., belonging to an addressee), and/or other such device. In an aspect, the systems and various embodiments disclosed herein are capable of deployment over a cloud computing infrastructure that can allow for a ubiquitous, convenient, on-demand network access to a shared pool of configurable computing resources (e.g., networks, applications, servers, storage, and services). In some instances, such resources can be provided with minimal effort or service provider interaction. In an aspect, the cloud model can include characteristics such as on-demand self-service, broad network access, resource pooling, rapid elasticity, and/or measured service. Furthermore, the systems disclosed herein can employ cloud service models such as software as a service, platform as a service and/or infrastructure as a service. Also, in an aspect, the systems disclosed herein can employ any of several deployment models including a private cloud, community cloud, public cloud, and/or hybrid cloud.

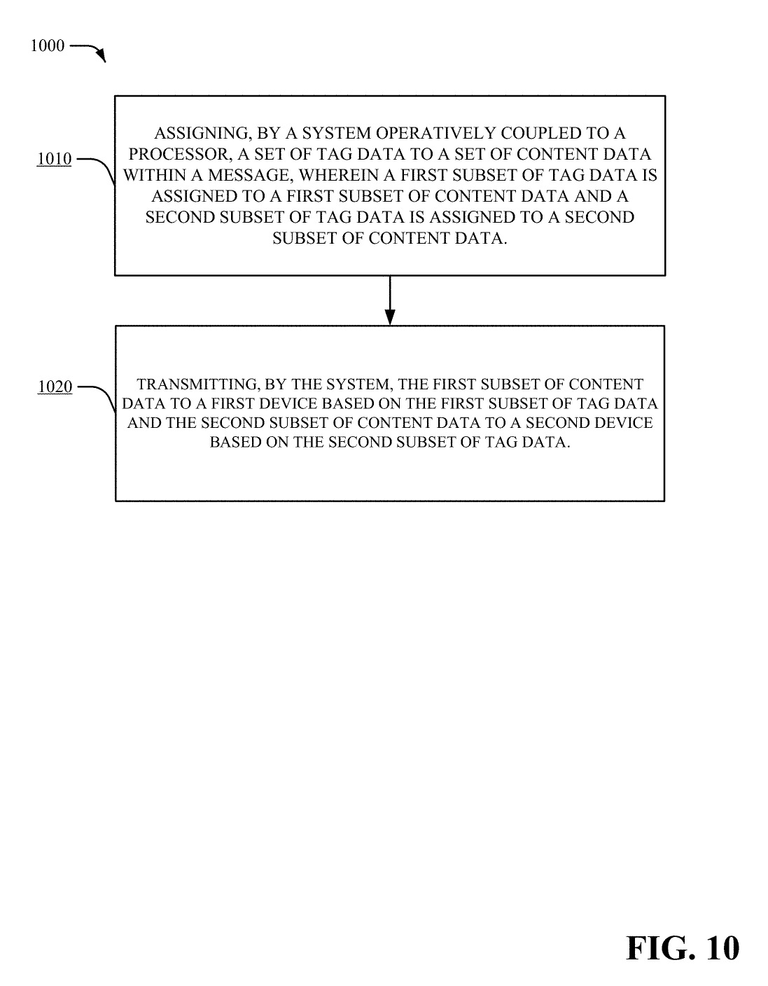

Turning now to FIG. 10, illustrated is a flow diagram of an example, non-limiting computer-implemented method 1000 that can facilitate a transmission of segments of global content and local content as several varied email messages to several destinations in a single transmission instance. Repetitive description of like elements employed in other embodiments described herein is omitted for sake of brevity.

In an aspect, one or more of the components described in computer-implemented method 1000 can be electrically and/or communicatively coupled to one or more devices. In some implementations, at reference numeral 1010, a system operatively coupled to a processor (e.g., processor 112) can assign (e.g., using tagging component 110) a set of tag data to a set of content data within a message, wherein a first subset of tag data is assigned to a first subset of content data and a second subset of tag data is assigned to a second subset of tag data is assigned to a second subset of content data. In another implementation, at reference numeral 1020, the system can transmit (e.g., using transmission component 120) the first subset of content data to a first device based on the first subset of tag data and the second subset of content data to a second device based on the second subset of tag data.

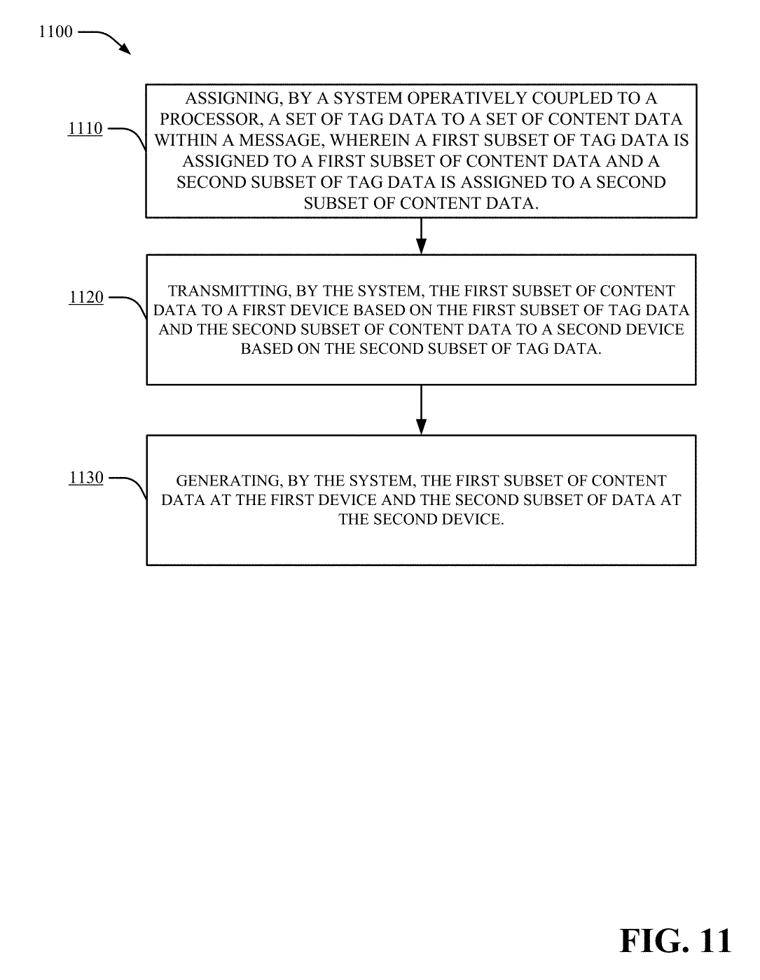

Turning now to FIG. 11, illustrated is a flow diagram of an example, non-limiting computer-implemented method 1100 that can facilitate a transmission of segments of global content and local content as several varied email messages to several destinations in a single transmission instance. Repetitive description of like elements employed in other embodiments described herein is omitted for sake of brevity.

In an aspect, one or more of the components described in computer-implemented method 1100 can be electrically and/or communicatively coupled to one or more devices. In some implementations, at reference numeral 1110, a system operatively coupled to a processor (e.g., processor 112) can assign (e.g., using tagging component 110) a set of tag data to a set of content data within a message, wherein a first subset of tag data is assigned to a first subset of content data and a second subset of tag data is assigned to a second subset of tag data is assigned to a second subset of content data. In another implementation, at reference numeral 1120, the system can transmit (e.g., using transmission component 120) the first subset of content data to a first device based on the first subset of tag data and the second subset of content data to a second device based on the second subset of tag data. At reference numeral 1130, the system can generate (e.g., using generation component 210) the first subset of content data at the first device and the second subset of data at the second device.

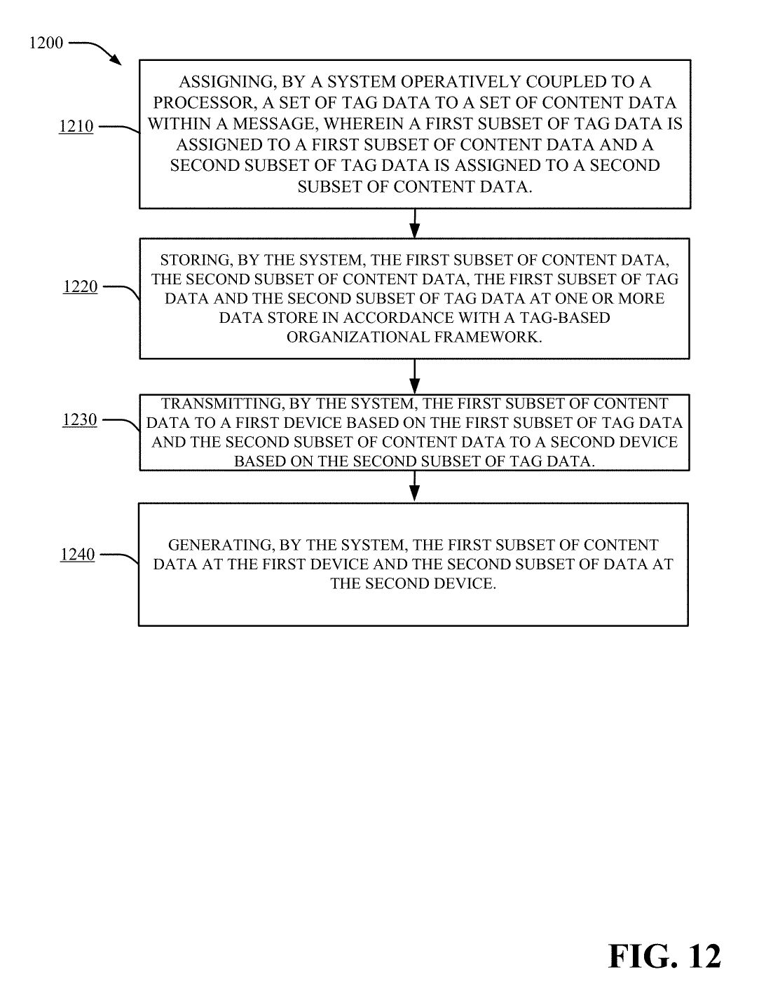

Turning now to FIG. 12, illustrated is a flow diagram of an example, non-limiting computer-implemented method 1200 that can facilitate a transmission of segments of global content and local content as several varied email messages to several destinations in a single transmission instance. Repetitive description of like elements employed in other embodiments described herein is omitted for sake of brevity.

In an aspect, one or more of the components described in computer-implemented method 1200 can be electrically and/or communicatively coupled to one or more devices. In some implementations, at reference numeral 1210, a system operatively coupled to a processor (e.g., processor 112) can assign (e.g., using tagging component 110) a set of tag data to a set of content data within a message, wherein a first subset of tag data is assigned to a first subset of content data and a second subset of tag data is assigned to a second subset of tag data is assigned to a second subset of content data. In another implementation, at reference numeral 1220, the system can store (e.g., using indexing component 310) the first subset of content data, the second subset of content data, the first subset of tag data and the second subset of tag data at one or more data store in accordance with a tag based organizational framework.

At reference numeral 1230, the system can transmit (e.g., using transmission component 120) the first subset of content data to a first device based on the first subset of tag data and the second subset of content data to a second device based on the second subset of tag data. At reference numeral 1240, the system can generate (e.g., using generation component 210) the first subset of content data at the first device and the second subset of data at the second device.

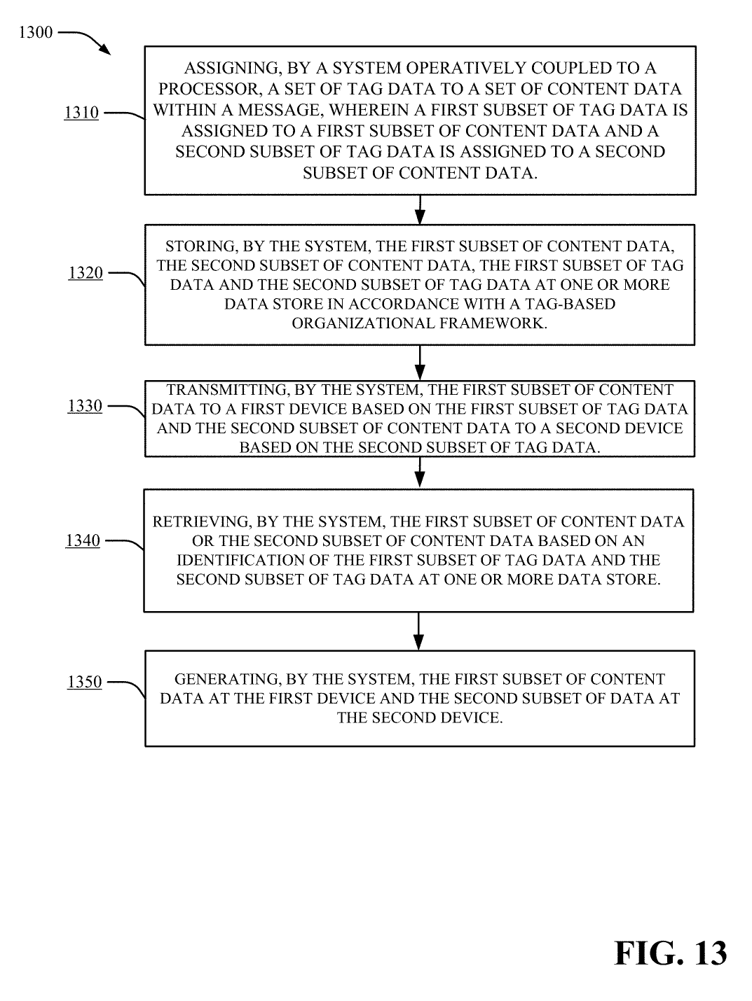

Turning now to FIG. 13, illustrated is a flow diagram of an example, non-limiting computer-implemented method 1300 that can facilitate a transmission of segments of global content and local content as several varied email messages to several destinations in a single transmission instance. Repetitive description of like elements employed in other embodiments described herein is omitted for sake of brevity.

In an aspect, one or more of the components described in computer-implemented method 1300 can be electrically and/or communicatively coupled to one or more devices. In some implementations, at reference numeral 1310, a system operatively coupled to a processor (e.g., processor 112) can assign (e.g., using tagging component 110) a set of tag data to a set of content data within a message, wherein a first subset of tag data is assigned to a first subset of content data and a second subset of tag data is assigned to a second subset of tag data is assigned to a second subset of content data. In another implementation, at reference numeral 1320, the system can store (e.g., using indexing component 310) the first subset of content data, the second subset of content data, the first subset of tag data and the second subset of tag data at one or more data store in accordance with a tag-based organizational framework.

At reference numeral 1330, the system can transmit (e.g., using transmission component 120) the first subset of content data to a first device based on the first subset of tag data and the second subset of content data to a second device based on the second subset of tag data. At reference numeral 1340, the system can retrieve (e.g., using searching component 410) the first subset of content data or the second subset of content data based on an identification of the first subset of tag data and the second subset of tag data at one or more data store. At reference numeral 1350, the system can generate (e.g., using generation component 210) the first subset of content data at the first device and the second subset of data at the second device.

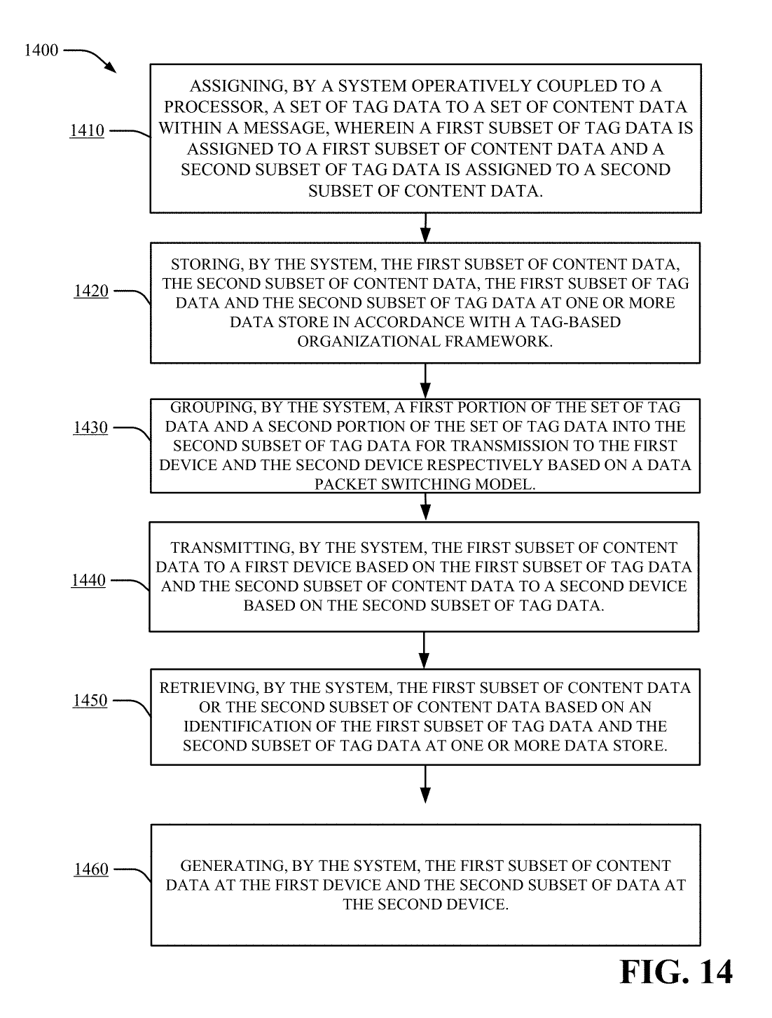

Turning now to FIG. 14, illustrated is a flow diagram of an example, non-limiting computer-implemented method 1400 that can facilitate a transmission of segments of global content and local content as several varied email messages to several destinations in a single transmission instance. Repetitive description of like elements employed in other embodiments described herein is omitted for sake of brevity.

In an aspect, one or more of the components described in computer-implemented method 1400 can be electrically and/or communicatively coupled to one or more devices. In some implementations, at reference numeral 1410, a system operatively coupled to a processor (e.g., processor 112) can assign (e.g., using tagging component 110) a set of tag data to a set of content data within a message, wherein a first subset of tag data is assigned to a first subset of content data and a second subset of tag data is assigned to a second subset of tag data is assigned to a second subset of content data. In another implementation, at reference numeral 1420, the system can store (e.g., using indexing component 310) the first subset of content data, the second subset of content data, the first subset of tag data and the second subset of tag data at one or more data store in accordance with a tag based organizational framework.

At reference numeral 1430, the system can group (e.g., using grouping component 510) a first portion of the set of tag data and a second portion of the set of tag data into the second subset of tag data for transmission to the first device and the second device respectively based on a data packet switching model. At reference numeral 1440, the system can transmit (e.g., using transmission component 120) the first subset of content data to a first device based on the first subset of tag data and the second subset of content data to a second device based on the second subset of tag data. At reference numeral 1450, the system can retrieve (e.g., using searching component 410) the first subset of content data or the second subset of content data based on an identification of the first subset of tag data and the second subset of tag data at one or more data store. At reference numeral 1460, the system can generate (e.g., using generation component 210) the first subset of content data at the first device and the second subset of data at the second device.

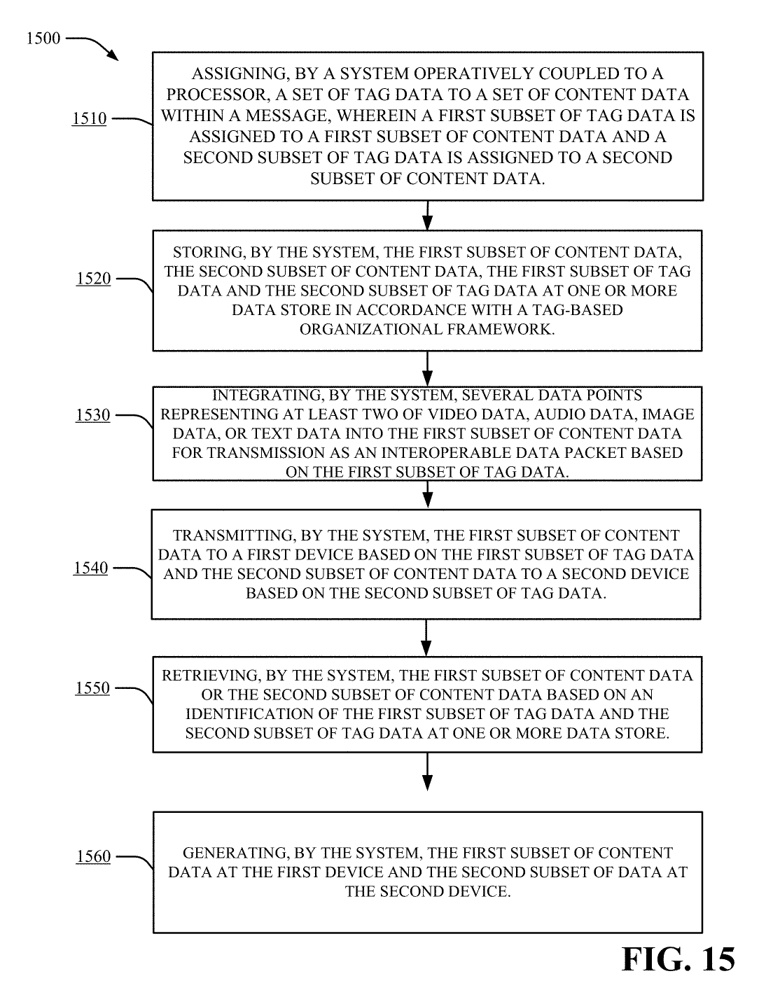

Turning now to FIG. 15, illustrated is a flow diagram of an example, non-limiting computer-implemented method 1500 that can facilitate a transmission of segments of global content and local content as several varied email messages to several destinations in a single transmission instance. Repetitive description of like elements employed in other embodiments described herein is omitted for sake of brevity.

In an aspect, one or more of the components described in computer-implemented method 1500 can be electrically and/or communicatively coupled to one or more devices. In some implementations, at reference numeral 1510, a system operatively coupled to a processor (e.g., processor 112) can assign (e.g., using tagging component 110) a set of tag data to a set of content data within a message, wherein a first subset of tag data is assigned to a first subset of content data and a second subset of tag data is assigned to a second subset of tag data is assigned to a second subset of content data. In another implementation, at reference numeral 1520, the system can store (e.g., using indexing component 310) the first subset of content data, the second subset of content data, the first subset of tag data and the second subset of tag data at one or more data store in accordance with a tag based organizational framework.

At reference numeral 1530, the system can integrate (e.g., using integration component 710) data points representing at least two of video data, audio data, image data, or text data into the first subset of content data for transmission as an interoperable data packet based on the first subset of tag data. At reference numeral 1540, the system can transmit (e.g., using transmission component 120) the first subset of content data to a first device based on the first subset of tag data and the second subset of content data to a second device based on the second subset of tag data. At reference numeral 1550, the system can retrieve (e.g., using searching component 410) the first subset of content data or the second subset of content data based on an identification of the first subset of tag data and the second subset of tag data at one or more data store. At reference numeral 1560, the system can generate (e.g., using generation component 210) the first subset of content data at the first device and the second subset of data at the second device.

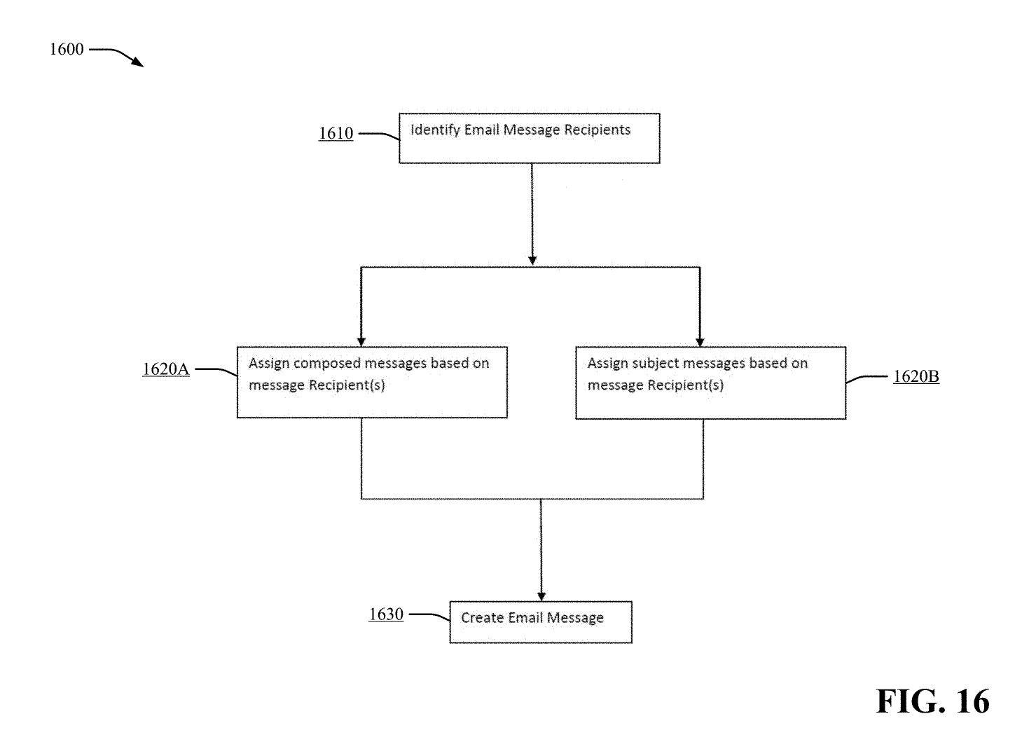

Turning now to FIG. 16, illustrated is a flow diagram of an example, non-limiting computer-implemented method 1600 that can facilitate a transmission of segments of global content and local content as several varied email messages to several destinations in a single transmission instance. Repetitive description of like elements employed in other embodiments described herein is omitted for sake of brevity.

In an aspect, one or more of the components described in computer-implemented method 1600 can be electrically and/or communicatively coupled to one or more devices. In some implementations, at reference numeral 1610, a system operatively coupled to a processor (e.g., processor 112) can identify email message recipients. At reference numeral 1620A, the system can assign (e.g., using tagging component 110) composed messages based on message recipients. At reference numeral 1620B, the system can assign (e.g., using tagging component 110) subject messages based on message recipients. At reference numeral 1630, the system can create an email message.

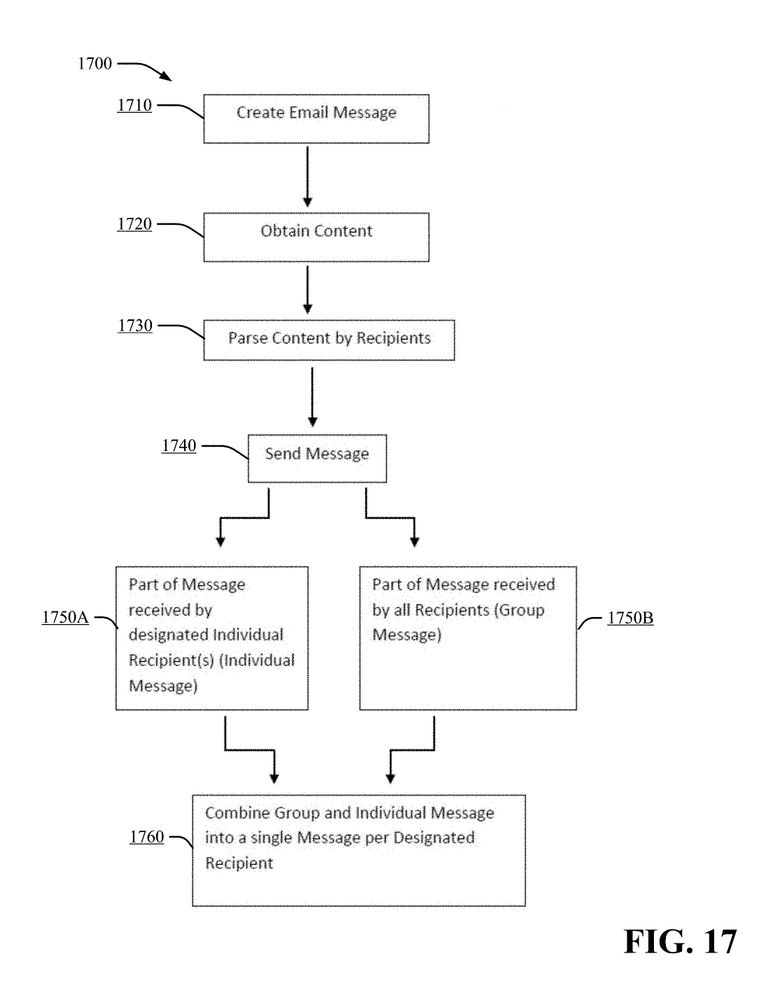

Turning now to FIG. 17, illustrated is a flow diagram of an example, non-limiting computer-implemented method 1700 that can facilitate a transmission of segments of global content and local content as several varied email messages to several destinations in a single transmission instance. Repetitive description of like elements employed in other embodiments described herein is omitted for sake of brevity.

In an aspect, one or more of the components described in computer-implemented method 1600 can be electrically and/or communicatively coupled to one or more devices. In some implementations, at reference numeral 1710, a system operatively coupled to a processor (e.g., processor 112) can create an email message. At reference numeral 1720, the system can obtain content. At reference numeral 1730, the system can parse content by recipients. At reference numeral 1740, the system can send messages. At reference numeral 1750A, a part of a message can be received by a designated recipient as an individual message. At reference numeral 1750B, a part of a message can be received by all recipients as a group of messages. At reference numeral 1760, group messages and individual messages can be combined into a single message per respective recipients.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art can understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Aspects disclosed herein can be integrated with the tangible and physical infrastructure components of a cloud computing network or physical device architecture that include user devices, servers, and/or storage devices. Furthermore, the systems disclosed herein can utilize techniques that that a human cannot perform such as the deployment of cryptographic hash identification mechanisms. For instance, a human cannot employ the processing power required to identify thousands of emails messages in a short duration of time (e.g., seconds). Furthermore, a human cannot partition a single email message into several (e.g., hundreds) of variant messages for transmission to several (e.g., hundreds) of devices in a single send instance. Furthermore, a human is unable to simultaneously access and employ ungrouped message data, grouped message data, tag data associated with grouped and ungrouped message data, artificial intelligence generated (e.g., using generation component 210) data and/or packetized data for communication between a main processor (e.g., using processor 112) and a memory (e.g., memory 108) to simultaneously facilitate the transmission of several thousands of email messages from one single composed email message simultaneously.

Moreover, because in a non-limiting embodiment a transmission, tagging and/or grouping of data is performed utilizing iterative machine learning and artificial intelligence techniques that facilitate a recurrent and precise grouping email message content based on similarity comparisons and tag data performed by components executed by a processor (e.g., processor 112) established from a combination of electrical and mechanical components and circuitry, a human is unable to replicate or perform the subject data packet configuration and/or the subject communication between processing components, a tagging component 110, and a transmission component 120. Furthermore, in another embodiment, the generation (e.g., using generation component) of digital data based on pattern recognition algorithms and data similarity algorithms as well as storage and retrieval of digitally generated data to and from a memory (e.g., using memory 108) in accordance with computer generated access patterns cannot be replicated by a human.

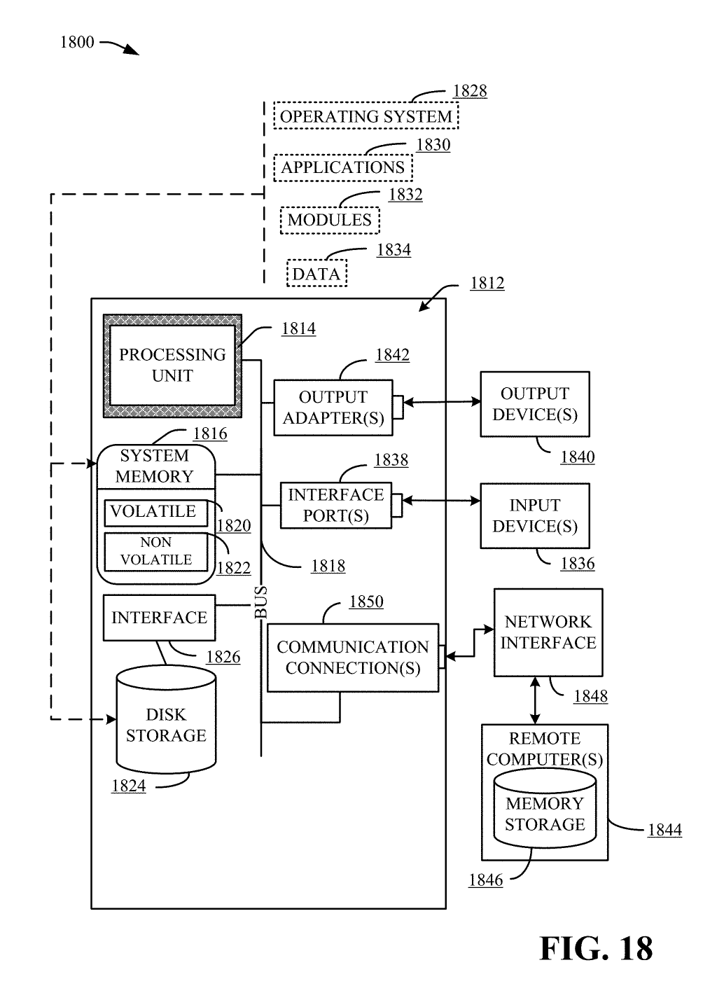

In order to provide a context for the various aspects of the disclosed subject matter, FIG. 18 as well as the following discussion is intended to provide a general description of a suitable environment in which the various aspects of the disclosed subject matter can be implemented. FIG. 18 illustrates a block diagram of an example, non-limiting operating environment in which one or more embodiments described herein can be facilitated. With reference to FIG. 18, a suitable operating environment 1800 for implementing various aspects of this disclosure can also include a computer 1812. The computer 1812 can also include a processing unit 1814, a system memory 1816, and a system bus 1818. The system bus 1818 couples system components including, but not limited to, the system memory 1816 to the processing unit 1814. The processing unit 1814 can be any of various available processors. Dual microprocessors and other multiprocessor architectures also can be employed as the processing unit 1814. The system bus 1818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1816 can also include volatile memory 1820 and nonvolatile memory 1822. The basic input/output system (BIOS), containing the basic routines to transfer information between elements within the computer 1812, such as during start-up, is stored in nonvolatile memory 1822. By way of illustration, and not limitation, nonvolatile memory 1822 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1812 can also include removable/non-removable, volatile/non-volatile computer storage media. FIG. 18 illustrates, for example, a disk storage 1824. Disk storage 1824 can also include, but is not limited to, devices like a magnetic disk drive, floppy disk drive, tape drive, Jaz drive, Zip drive, LS-100 drive, flash memory card, or memory stick. The disk storage 1824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1824 to the system bus 1818, a removable or non-removable interface is typically used, such as interface 1826. FIG. 18 also depicts software that acts as an intermediary between users and the basic computer resources described in the suitable operating environment 1800. Such software can also include, for example, an operating system 1828. Operating system 1828, which can be stored on disk storage 1824, acts to control and allocate resources of the computer 1812.

System applications 1830 take advantage of the management of resources by operating system 1828 through program modules 1832 and program data 1834, e.g., stored either in system memory 1816 or on disk storage 1824. It is to be appreciated that this disclosure can be implemented with various operating systems or combinations of operating systems. A user enters commands or information into the computer 1812 through input device(s) 1836. Input devices 1836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1814 through the system bus 1818 via interface port(s) 1838. Interface port(s) 1838 include, for example, a serial port, a parallel port, a game port, and a universal serial bus (USB). Output device(s) 1840 use some of the same type of ports as input device(s) 1836. Thus, for example, a USB port can be used to provide input to computer 1812, and to output information from computer 1812 to an output device 1840. Output adapter 1242 is provided to illustrate that there are some output device 1840 like monitors, speakers, and printers, among other such output device 1840, which require special adapters. The output adapters 1842 include, by way of illustration and not limitation, video and sound cards that provide a means of connection between the output device 1840 and the system bus 1818. It should be noted that other devices and/or systems of devices provide both input and output capabilities such as remote computer(s) 1844.

Computer 1812 can operate in a networked environment using logical connections to one or more remote computers, such as remote computer(s) 1844. The remote computer(s) 1844 can be a computer, a server, a router, a network PC, a workstation, a microprocessor based appliance, a peer device or other common network node and the like, and typically can also include many or all of the elements described relative to computer 1812. For purposes of brevity, only a memory storage device 1846 is illustrated with remote computer(s) 1844. Remote computer(s) 1844 is logically connected to computer 1812 through a network interface 1848 and then physically connected via communication connection 1850. Network interface 1848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1850 refers to the hardware/software employed to connect the network interface 1848 to the system bus 1818. While communication connection 1850 is shown for illustrative clarity inside computer 1812, it can also be external to computer 1812. The hardware/software for connection to the network interface 1848 can also include, for exemplary purposes only, internal and external technologies such as, modems including regular telephone grade modems, cable modems and DSL modems, ISDN adapters, and Ethernet cards.

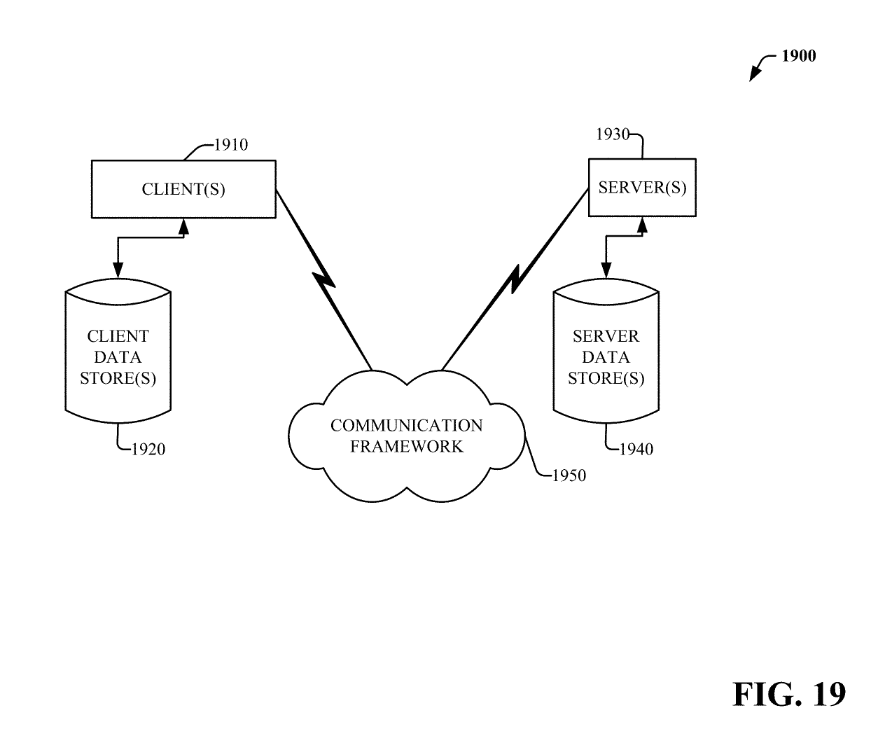

Referring now to FIG. 19, there is illustrated a schematic block diagram of a computing environment 1900 in accordance with this disclosure. The system 1900 includes one or more client(s) 1902 (e.g., laptops, smart phones, PDAs, media players, computers, portable electronic devices, tablets, and the like). The client(s) 1902 can be hardware and/or software (e.g., threads, processes, computing devices). The system 1900 also includes one or more server(s) 1904. The server(s) 1904 can also be hardware or hardware in combination with software (e.g., threads, processes, computing devices). The servers 1904 can house threads to perform transformations by employing aspects of this disclosure, for example. One possible communication between a client 1902 and a server 1904 can be in the form of a data packet transmitted between two or more computer processes wherein the data packet may include video data. The data packet can include a metadata, e.g., associated contextual information, for example. The system 1900 includes a communication framework 1906 (e.g., a global communication network such as the Internet, or mobile network(s)) that can be employed to facilitate communications between the client(s) 1902 and the server(s) 1904.

Communications can be facilitated via a wired (including optical fiber) and/or wireless technology. The client(s) 1902 include or are operatively connected to one or more client data store(s) 1908 that can be employed to store information local to the client(s) 1902 (e.g., associated contextual information). Similarly, the server(s) 1904 are operatively include or are operatively connected to one or more server data store(s) 1910 that can be employed to store information local to the servers 1904. In one embodiment, a client 1902 can transfer an encoded file, in accordance with the disclosed subject matter, to server 1904. Server 1904 can store the file, decode the file, or transmit the file to another client 1902. It is to be appreciated, that a client 1902 can also transfer uncompressed file to a server 1904 and server 1904 can compress the file in accordance with the disclosed subject matter. Likewise, server 1904 can encode video information and transmit the information via communication framework 1906 to one or more clients 1902.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes the computer executable components stored in the memory, wherein the computer executable components comprise:
a tagging component that assigns a set of tag data to a set of content data within a message, wherein at least a first subset of tag data is assigned to at least a first subset of content data and at least a second subset of tag data is assigned to at least a second subset of content data;
a transmission component that transmits at least the first subset of content data to a first device based on the first subset of tag data and at least the second subset of content data that is different than the first subset of content data to a second device based on the second subset of tag data.

2. The system of claim 1, wherein a transmission of the first subset of content data and the second subset of content data at occurs in one transmission instance.

3. The system of claim 1, further comprising a generation component that generates the first subset of content data at the first device and the second subset of data at the second device.

4. The system of claim 1, wherein the first subset of content data and the second subset of content data represent at least one of entirely different content, at least a portion of different content and at least a portion of same content, or entirely same content.

5. The system of claim 1, further comprising an indexing component that stores the first subset of content data, the second subset of content data, the first subset of tag data and the second subset of tag data at one or more data store in accordance with a tag-based organizational framework.

6. The system of claim 1, further comprising a searching component that retrieves the first subset of content data or the second subset of content data based on an identification of the first subset of tag data and the second subset of tag data at one or more data store.

7. The system of claim 1, further comprising a grouping component that group a first portion of the set of tag data and a second portion of the set of tag data into the second subset of tag data for transmission to the first device and the second device respectively based on a data packet switching model.

8. The system of claim 1, wherein the first subset of content data and the second subset of content data can comprise at least one of video data, audio data, text data, or image data.

9. The system of claim 1, further comprising a translation component that translates the first subset of content data or the second subset of content data from a first language representation to a second language representation based on a correlation between a set of translation data and the first subset of tag data or the second subset of tag data respectively.

10. The system of claim 1, further comprising an integration component that integrates several data points representing at least two of video data, audio data, image data, or text data into the first subset of content data for transmission as an interoperable data packet based on the first subset of tag data.

11. The system of claim 1, further comprising a presentation component that transmits the first subset of content data to a first content sharing platform and the second subset of content data to a second content sharing platform based on a third subset of tag data and a fourth subset of tag data respectively, wherein the third subset of tag data and the fourth subset of tag data represent mapping information to locations associated with the first content sharing platform and the second content sharing platform.

12. A computer-implemented method, comprising:
assigning, by a system operatively coupled to a processor, a set of tag data to a set of content data within a message, wherein a first subset of tag data is assigned to a first subset of content data and a second subset of tag data is assigned to a second subset of content data; and
transmitting, by the system, the first subset of content data to a first device based on the first subset of tag data and the second subset of content data to a second device based on the second subset of tag data.

13. The computer-implemented method of claim 12, further comprising generating, by the system, the first subset of content data at the first device and the second subset of data at the second device.

14. The computer-implemented method of claim 12, further comprising storing, by the system, the first subset of content data, the second subset of content data, the first subset of tag data and the second subset of tag data at one or more data store in accordance with a tag-based organizational framework.

15. The computer-implemented method of claim 12, further comprising retrieving, by the system, the first subset of content data or the second subset of content data based on an identification of the first subset of tag data and the second subset of tag data at one or more data store.

16. The computer-implemented method of claim 12, further comprising grouping, by the system, a first portion of the set of tag data and a second portion of the set of tag data into the second subset of tag data for transmission to the first device and the second device respectively based on a data packet switching model.

17. The computer-implemented method of claim 12, further comprising translating, by the system, the first subset of content data or the second subset of content data from a first language representation to a second language representation based on a correlation between a set of translation data and the first subset of tag data or the second subset of tag data respectively.

18. The computer-implemented method of claim 12, further comprising integrating, by the system, several data points representing at least two of video data, audio data, image data, or text data into the first subset of content data for transmission as an interoperable data packet based on the first subset of tag data.

19. A computer program product for facilitating a grouping disparate content data points into interoperable data packets for transmission over as mutual content data subsets and individualized content data subsets over a single messaging instance, the computer program product comprising a computer readable storage medium having program instructions embodied therewith, the program instructions executable by a processor to cause the processor to:
assign a set of tag data to a set of content data within a message, wherein a first subset of tag data is assigned to a first subset of content data and a second subset of tag data is assigned to a second subset of content data; and
transmit the first subset of content data to a first device based on the first subset of tag data and the second subset of content data to a second device based on the second subset of tag data.

20. The computer program product of claim 19, wherein the program instructions are further executable by the processor to cause the processor to:
transmit the first subset of content data to a first content sharing platform and the second subset of content data to a second content sharing platform based on a third subset of tag data and a fourth subset of tag data respectively, wherein the third subset of tag data and the fourth subset of tag data represent mapping information to locations associated with the first content sharing platform and the second content sharing platform.
